(19) United States
(12) Patent Application Publication
(10) Pub. No.: US 2026/0003937 A1
(43) Pub. Date: Jan. 1, 2026

(54) CROSS-DOMAIN RECOMMENDATION MODEL SAMPLE PROCESSING

(71) Applicant: Tencent Technology (Shenzhen) Company Limited, Shenzhen (CN)

(72) Inventors: Haokai MA, Shenzhen (CN); Ruobing XIE, Shenzhen (CN); Lei MENG, Shenzhen (CN); Xin CHEN, Shenzhen (CN); Xu ZHANG, Shenzhen (CN); Leyu LIN, Shenzhen (CN); Jie ZHOU, Shenzhen (CN)

(73) Assignee: Tencent Technology (Shenzhen) Company Limited, Shenzhen (CN)

(21) Appl. No.: 19/319,196

(22) Filed: Sep. 4, 2025

Related U.S. Application Data
(63) Continuation of application No. PCT/CN2024/087977, filed on Apr. 16, 2024.

(30) Foreign Application Priority Data
Jun. 12, 2023 (CN) 202310694404.4

(51) Int. Cl. G06F 18/22; G06F 17/16; G06F 18/2113; G06F 18/213; G06F 18/214; G06F 18/25; G06N 3/048

(52) U.S. Cl. CPC G06F 18/22; G06F 17/16; G06F 18/2113; G06F 18/213; G06F 18/214; G06F 18/253; G06N 3/048

(57) ABSTRACT

In a method, a plurality of recommended items in a target domain is obtained. A first interaction feature of a sample object in a source domain is fused with a second interaction feature of the sample object in the target domain to obtain a fused interaction feature. Similarity scores between the fused interaction feature and each of the plurality of recommended items are determined. A plurality of hard negative samples (HNSs) is filtered from the plurality of recommended items based on the similarity scores. The plurality of HNSs is combined into a candidate recommended item set. A third interaction feature is fused with a fourth interaction feature to obtain a transfer interaction feature. A plurality of real hard negative samples (RHNSs) is filtered from the plurality of HNSs based on similarity scores between the transfer interaction feature and each of the plurality of HNSs.

### RELATED APPLICATIONS

The present application is a continuation of International Application No. PCT/CN2024/087977, filed on Apr. 16, 2024, which claims priority to Chinese Patent Application No. 2023106944044, filed on Jun. 12, 2023. The entire disclosures of the prior applications are hereby incorporated herein by reference.

### FIELD OF THE TECHNOLOGY

This application relates to artificial intelligence (AI) technologies, including a sample processing method for a cross-domain recommendation (CDR) model.

### BACKGROUND OF THE DISCLOSURE

AI is a theory, method, technology, and application system that uses a digital computer or a machine controlled by the digital computer to simulate, extend, and expand human intelligence, perceive an environment, acquire knowledge, and use knowledge to obtain an optimal result.

Item recommendation is an important application of AI. In related art, an item is recommended to an object by using a recommendation model, but recommendation accuracy of the recommendation model depends on a training effect of the model. CDR is using rich object behavior information in a source domain as an aid in a target domain, so that better recommendation can be performed in the target domain or even in a plurality of domains. In related art, for samples for training a CDR model, a CDR method focuses on feature-level cross-domain correlations of negative samples (NSs) randomly extracted from a target domain, and the CDR model obtained through training does not have high precision in recommending information in the target domain, affecting accuracy of information recommendation.

In related art, there is still no effective solution to the problem of low accuracy of performing CDR by a CDR model.

### SUMMARY

Aspects of this disclosure include a sample processing method, an apparatus for a CDR model, and a non-transitory computer-readable storage medium to improve accuracy of performing recommendation by a CDR model in a target domain.

Examples of technical solutions of this disclosure may be implemented as follows:

An aspect of this disclosure provides a method for processing samples for a cross-domain recommendation (CDR) model, in which a plurality of recommended items in a target domain is obtained. A first interaction feature of a sample object in a source domain is fused with a second interaction feature of the sample object in the target domain to obtain a fused interaction feature of the sample object. Similarity scores between the fused interaction feature and each of the plurality of recommended items are determined. A plurality of hard negative samples (HNSs) is filtered from the plurality of recommended items based on the similarity scores. The plurality of HNSs is combined into a candidate recommended item set. A third interaction feature is fused with a fourth interaction feature to obtain a transfer interaction feature of the sample object. The third interaction feature indicates time-sensitive interaction behavior of the sample object in the source domain. The fourth interaction feature indicates a cluster center of the second interaction feature. A plurality of real hard negative samples (RHNSs) is filtered from the plurality of HNSs based on similarity scores between the transfer interaction feature and each of the plurality of HNSs in the candidate recommended item set. The plurality of RHNSs is used to train the CDR model.

An aspect of this disclosure provides an apparatus for processing samples for a cross-domain recommendation (CDR) model. The apparatus includes processing circuitry configured to obtain a plurality of recommended items in a target domain. The processing circuitry is configured to fuse a first interaction feature of a sample object in a source domain with a second interaction feature of the sample object in the target domain to obtain a fused interaction feature of the sample object. The processing circuitry is configured to determine similarity scores between the fused interaction feature and each of the plurality of recommended items. The processing circuitry is configured to filter a plurality of hard negative samples (HNSs) from the plurality of recommended items based on the similarity scores. The processing circuitry is configured to combine the plurality of HNSs into a candidate recommended item set. The processing circuitry is configured to fuse a third interaction feature with a fourth interaction feature to obtain a transfer interaction feature of the sample object. The third interaction feature indicates time-sensitive interaction behavior of the sample object in the source domain. The fourth interaction feature indicates a cluster center of the second interaction feature. The processing circuitry is configured to filter a plurality of real hard negative samples (RHNSs) from the plurality of HNSs based on similarity scores between the transfer interaction feature and each of the plurality of HNSs in the candidate recommended item set. The plurality of RHNSs is used to train the CDR model.

An aspect of this disclosure provides a sample processing method for a CDR model, the method being performed by an electronic device, and the method including: obtaining a plurality of recommended items in a target domain; fusing a first interaction feature of a sample object in a source domain and a second interaction feature of the sample object in the target domain, to obtain a fused interaction feature of the sample object; determining similarity indexes between the fused interaction feature and all the recommended items; filtering a plurality of hard negative samples (HNSs) from the plurality of recommended items based on the similarity indexes, and combining the plurality of HNSs into a set of candidate recommended items; fusing a third interaction feature of an interactive behavior that is of the sample object and that is time-effective in the source domain and a fourth interaction feature representing a cluster center of the second interaction feature, to obtain a transfer interaction feature of the sample object; and filtering a plurality of real hard negative samples (RHNSs) from the plurality of HNSs based on similarity indexes between the transfer interaction feature and all recommended items in the set of candidate recommended items, the plurality of RHNSs being configured for training the CDR model.

An aspect of this disclosure provides a sample processing apparatus for a CDR model, including: a sample obtaining module, configured to obtain a plurality of recommended items in a target domain, the sample obtaining module being configured to fuse a first interaction feature of a sample object in a source domain and a second interaction feature of the sample object in the target domain, to obtain a fused interaction feature of the sample object; and a sample filtering module, configured to determine similarity indexes between the fused interaction feature and all the recommended items; and filter a plurality of HNSs from the plurality of recommended items based on the similarity indexes, and combine the plurality of HNSs into a set of candidate recommended items, the sample obtaining module being configured to fuse a third interaction feature of an interactive behavior that is of the sample object and that is time-effective in the source domain and a fourth interaction feature representing a cluster center of the second interaction feature, to obtain a transfer interaction feature of the sample object; and the sample filtering module being configured to filter a plurality of RHNSs from the plurality of HNSs based on similarity indexes between the transfer interaction feature and all recommended items in the set of candidate recommended items, the plurality of RHNSs being configured for training the CDR model.

An aspect of this disclosure provides an electronic device, the electronic device including: a memory, configured to store computer-executable instructions; and a processor, configured to implement, when executing the computer-executable instructions stored in the memory, the sample processing method for a CDR model provided in the aspects of this disclosure.

An aspect of this disclosure provides a non-transitory computer-readable storage medium storing instructions which when executed by a processor cause the processor to perform the sample processing method for a CDR model provided in the aspects of this disclosure.

An aspect of this disclosure provides a computer program product, including a computer program or computer-executable instructions, the computer program or the computer-executable instructions, when executed by a processor, implementing the sample processing method for a CDR model provided in the aspects of this disclosure.

The aspects of this disclosure have the following beneficial effects:

A plurality of recommended items are initially filtered based on a fused interaction feature of a sample object between different domains, to obtain a set of candidate recommended items formed by combining HNSs. The set of candidate recommended items is filtered based on an interaction feature of a sample object transferred between different domains, to obtain RHNSs for training the CDR model. Through a plurality rounds of filtering, accuracy of RHNSs obtained through filtering is improved. The RHNSs obtained through filtering are configured for training the CDR model, which can improve accuracy of information recommendation of the model in the target domain.

### BRIEF DESCRIPTION OF THE DRAWINGS

FIG. 1 is a schematic diagram of an application mode of a sample processing method for a CDR model according to an aspect of this disclosure.

FIG. 2 is a schematic structural diagram of an electronic device according to an aspect of this disclosure.

FIG. 3A is a first schematic flowchart of a sample processing method for a CDR model according to an aspect of this disclosure.

FIG. 3B is a second schematic flowchart of a sample processing method for a CDR model according to an aspect of this disclosure.

FIG. 3C is a third schematic flowchart of a sample processing method for a CDR model according to an aspect of this disclosure.

FIG. 3D is a fourth schematic flowchart of a sample processing method for a CDR model according to an aspect of this disclosure.

FIG. 3E is a fifth schematic flowchart of a sample processing method for a CDR model according to an aspect of this disclosure.

FIG. 3F is a sixth schematic flowchart of a sample processing method for a CDR model according to an aspect of this disclosure.

FIG. 4A is a schematic diagram of a first relationship between a feature and a sample according to an aspect of this disclosure.

FIG. 4B is a schematic diagram of a second relationship between a feature and a sample according to an aspect of this disclosure.

FIG. 4C is a schematic diagram of a third relationship between a feature and a sample according to an aspect of this disclosure.

FIG. 5 is a seventh schematic flowchart of a sample processing method for a CDR model according to an aspect of this disclosure.

FIG. 6A shows a first experimental result table according to an aspect of this disclosure.

FIG. 6B shows a second experimental result table according to an aspect of this disclosure.

FIG. 6C shows a third experimental result table according to an aspect of this disclosure.

FIG. 6D shows a fourth experimental result table according to an aspect of this disclosure.

### DETAILED DESCRIPTION

To make the objectives, technical solutions, and advantages of this disclosure clearer, the following further describes this disclosure with reference to the accompanying drawings. The described aspects are not to be regarded as limitations on this disclosure. Other aspects shall fall within the scope of this disclosure. Further, the descriptions of the terms are provided as examples only and are not intended to limit the scope of the disclosure.

In the following descriptions, the term “some aspects” describes subsets of all possible aspects, but “some aspects” may be the same subset or different subsets of all the possible aspects, and can be combined with each other without conflict.

In the following descriptions, the included term “first/second/third” is merely intended to distinguish similar objects but does not necessarily indicate a specific order of an object. “First/second/third” is interchangeable in terms of a specific order or sequence if permitted, so that aspects of this disclosure described herein can be implemented in a sequence in addition to the sequence shown or described herein.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

Unless otherwise defined, all technical and scientific terms used herein have the same meanings that would be understood by a person skilled in the art to which the present disclosure belongs. Terms used in this specification are merely intended to describe examples of objectives of aspects of this disclosure, but are not intended to limit this disclosure.

Before aspects of this disclosure are further described in detail, examples of nouns and terms included in aspects of this disclosure are described, and the following explanations are applicable to the nouns and terms included in aspects of this disclosure
1) Item: An item is a target recommended by a recommendation system (for example, an advertising system), for example, an article (including an actual article such as food and clothing and an advertisement of a virtual article such as a game and a game prop), and information (such as an advertisement, news, and music).
2) Recommendation system: A recommendation system is a tool automatically associating users and information, can help users find information interesting them in an information-overloaded environment, and can also push information to users interested in the information.
3) CDR: CDR is a recommendation manner in which recommendation data in a source domain is used to assist in recommendation processing in a target domain. Assuming that a service A is used as a source domain and a service B is used as a target domain, rich object behavior information in the source domain is used as an aid in the target domain, so that better recommendation can be performed in the target domain or even in a plurality of domains. For example, a community website recommends books to users based on movie reviews made by the users. That is, it is assumed that a same user has similar preferences for movies and books.
4) NS: An NS is a relative concept. For a target class corresponding to a true value, the sample is a positive sample. For all other target classes not corresponding to the true value, the sample is an NS. A media information recommendation field is used as an example for explanation. A type of media information may be a text, an image, or a video. Samples are a plurality of pieces of to-be-recommended media information. An NS is media information with which a user does not interact. A positive sample is media information in which the user is interested and with which the user may interact. Types of interaction include: clicking, browsing, commenting, and the like.
5) HNS: An HNS is an NS that is difficult to be distinguished or classified from a positive sample, for example, an NS whose similarity with a positive sample is higher than a similarity threshold, which leads to a large prediction error. Using an advertisement field as an example, samples are a plurality of to-be-recommended advertisements. A positive sample is an advertisement of a corresponding product that a user may purchase. Therefore, features of an advertisement used as a positive sample include: the advertisement is related to an interest of a user, and the user clicks the advertisement and purchases a product corresponding to the advertisement. The HNS may be an advertisement that the user clicks, but does not purchase a product corresponding to the advertisement. For example, when a user already purchases an article corresponding to an advertisement A, the user may still be interested in the advertisement A, but would not purchase a product corresponding to the advertisement A after the user clicks the advertisement A. In this case, features of the advertisement A are very close to features corresponding to a positive sample, it is difficult to distinguish or classify the advertisement A, and the advertisement A is an HNS.
6) RHNS: An RHNS is a correctly classified NS, for example, is predicted as an NS, and is actually an NS. Description is continued based on the foregoing example of the HNS. If the advertisement A used as the HNS can be correctly distinguished by the recommendation model, and it is predicted that a type of the advertisement A is an NS, the advertisement A is an RHNS.
7) False hard negative sample (FHNS): An FHNS refers to a positive sample that is incorrectly marked as an NS, for example, is actually a positive sample, but is predicted as an NS. Description is continued based on the foregoing example of the HNS. If there is an advertisement B in advertisement samples, an actual type of the advertisement B is a positive sample, but the advertisement B is incorrectly predicted by the recommendation model as an NS, the advertisement B is an FHNS.
8) Transfer learning: Transfer learning is a term in machine learning, and refers to impact of one type of learning on another type of learning, or impact of learned experience on completing another activity. Transferring widely exists in learning of various knowledge, skills, and social norms.
9) Curriculum learning (CL): CL is a general training strategy, imitates a human learning sequence in a curriculum, and slowly increases difficulty of training samples as a model is optimized.
10) Collaborative filtering (CF): CF is recommending, based on preferences of a group having similar interests and common experience, information in which a user is interested, providing, by an individual, information feedback (for example, a score) through a cooperative mechanism, recording feedback content corresponding to the information, and performing information filtering based on the recorded feedback content, thereby assisting in filtering information in other domains.
11) Domain: A domain refers to a range or region or refers to a scope of academic thoughts or social activities. In aspects of this disclosure, a domain includes any type of domain in which information recommendation can be performed.
12) Cluster center: A cluster center is a special sample in cluster analysis and configured to represent a class. It is determined, by calculating a distance from another sample to the cluster center, whether the another sample belongs to the class.

In the related art, for samples for training a CDR model, a CDR method focuses only on feature-level cross-domain correlations of NSs randomly extracted from a target domain, and the CDR model obtained through training does not have high precision in recommending information in the target domain, affecting accuracy of information recommendation.

Aspects of this disclosure provide a sample processing method for a CDR model, a sample processing apparatus for a CDR model, an electronic device, a computer-readable storage medium, and a computer program product, to improve accuracy of performing recommendation by a CDR model in a target domain.

Example applications of the electronic device provided in aspects of this disclosure are described below. The electronic device provided in aspects of this disclosure may be implemented as various types of terminals such as a notebook computer, a tablet computer, a desktop computer, a set-top box, an in-vehicle terminal, a virtual reality (VR) device, and an augmented reality (AR) device, or may be implemented as a server. The following describes example applications in which the device is implemented as a terminal device or a server.

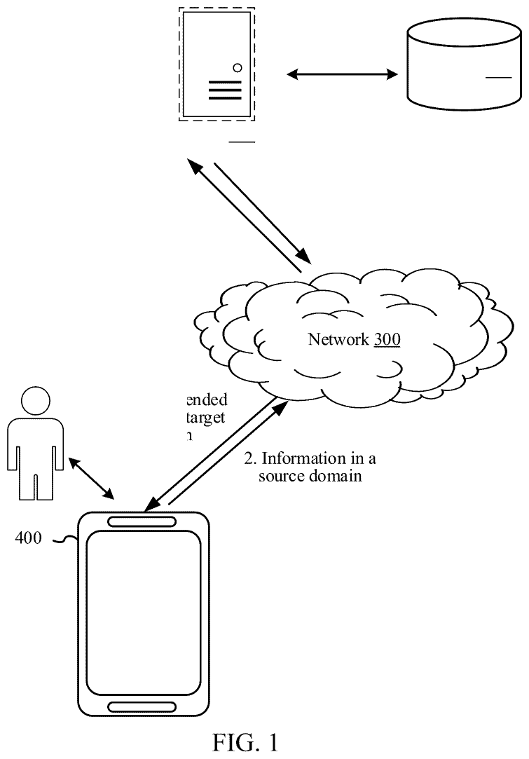

FIG. 1 is a schematic diagram of an application mode of a sample processing method for a CDR model according to an aspect of this disclosure. For example, FIG. 1 relates to a server 200, a network 300, a terminal device 400, and a database 500. The terminal device 400 is connected to the server 200 by the network 300. The network 300 may be a wide area network or a local area network, or a combination thereof.

In some aspects, the server 200 may be a training server, configured to train a CDR model. The database 500 has recommended items in at least two different domains stored therein. Types of the domains include: shopping information on different platforms, multimedia information on different platforms, and the like. For example, in a source domain, shopping information is recommended on a platform A, and in a target domain, shopping information is recommended on a platform B. In another example, a video is recommended in a source domain, and music is recommended in a target domain.

For example, the server 200 invokes the sample processing method for a CDR model provided in aspects of this disclosure to filter RHNSs from a plurality of sample recommended items, train the CDR model based on the RHNSs, and invoke and train the CDR model based on information about a user in a source domain, to recommend recommended items in a target domain to a terminal device 400 of the user. For example, the source domain is a movie domain, the target domain is a book domain, and based on preferences of a user in the movie domain, books that the user may prefer are recommended.

The aspects of this disclosure may be implemented by using a database technology. A database may be considered as an electronic file cabinet, that is, a place in which electronic files are stored. A user may perform an operation, such as adding, querying, updating, or deleting data, in the files. The so-called “database” is a data set that is stored together in a particular manner, can be shared by a plurality of users, has as less redundancy as possible, and is independent of an application.

A database management system (DBMS) is a computer software system designed to manage databases, and has basic functions such as storage, interception, security, and backup. The DBMS may be classified based on a database model that the DBMS supports, for example, a relational database model or an extensible markup language (XML) database model; or may be classified based on a type of computer that the DBMS supports, for example, a server cluster or a mobile phone; or may be classified based on a used query language, for example, a structured query language (SQL) or XQuery; or may be classified based on a performance impulse focus, for example, a maximum scale or a highest operation speed; or may be classified in another classification manner. Regardless of which classification manner is used, some DBMSs can cross classes, for example, support a plurality of query languages.

Aspects of this disclosure may alternatively be implemented through the cloud technology. The cloud technology is a collective name of a network technology, an information technology, an integration technology, a management platform technology, an application technology, and the like based on application of a cloud computing business mode, and may form a resource pool, which is used as required, and is flexible and convenient. The cloud computing technology becomes an important support. The back-end service of a technical network system requires many computing and storage resources, for example, video websites, image websites, and more portal websites. With the high-level development and application of the Internet industry, as well as the promotion of demands for search services, social networks, mobile commerce, and open collaboration, every article may have its own hash code identification mark in the future, and needs to be transmitted to a back-end system for logical processing. Data at different levels may be processed separately, and various types of industry data require strong system back support, which can only be implemented through cloud computing.

Aspects of this disclosure may be implemented with the help of the AI technology, which is a theory, method, technology, and application system that uses a digital computer or a machine controlled by the digital computer to simulate, extend, and expand human intelligence, perceive an environment, acquire knowledge, and use knowledge to obtain an optimal result. In other words, AI is a comprehensive technology in computer science. This technology attempts to understand the essence of intelligence and produce a new intelligent machine that can react in a manner similar to human intelligence. AI is to study the design principles and implementation methods of various intelligent machines, so that the machines can perceive, infer, and make decisions.

The AI technology is a comprehensive discipline, and relates to a wide range of fields, including both hardware-level technologies and software-level technologies. Basic AI technologies include technologies such as a sensor, a dedicated AI chip, cloud computing, distributed storage, a big data processing technology, a pre-trained model technology, an operating/interaction system, and electromechanical integration. The pre-trained model is also referred to as a large model or a basic model, and after fine adjustment, may be widely applied to downstream tasks in various large directions of AI. The AI software technologies mainly include several major directions such as a computer vision technology, a speech processing technology, a natural language processing technology, and machine learning/deep learning.

In some aspects, the server 200 may be implemented as a plurality of servers. For example, a sample processing server is configured to obtain training samples, a model training server is configured to train a CDR model, and an item recommendation server is configured to invoke a trained CDR model.

In some aspects, the server may be an independent physical server, or a server cluster or distributed system including a plurality of physical servers, or may be a cloud server for providing basic cloud computing services, such as a cloud service, a cloud database, cloud computing, a cloud function, cloud storage, a network service, cloud communication, a middleware service, a domain name service, a security service, a CDN, big data, and an artificial intelligence platform. The electronic device may be a smart phone, a tablet computer, a notebook computer, a desktop computer, a smart speaker, a smart watch, and the like, but is not limited thereto. The terminal device and the server may be directly or indirectly connected in a wired or wireless communication manner. This is not limited in the aspects of the present disclosure.

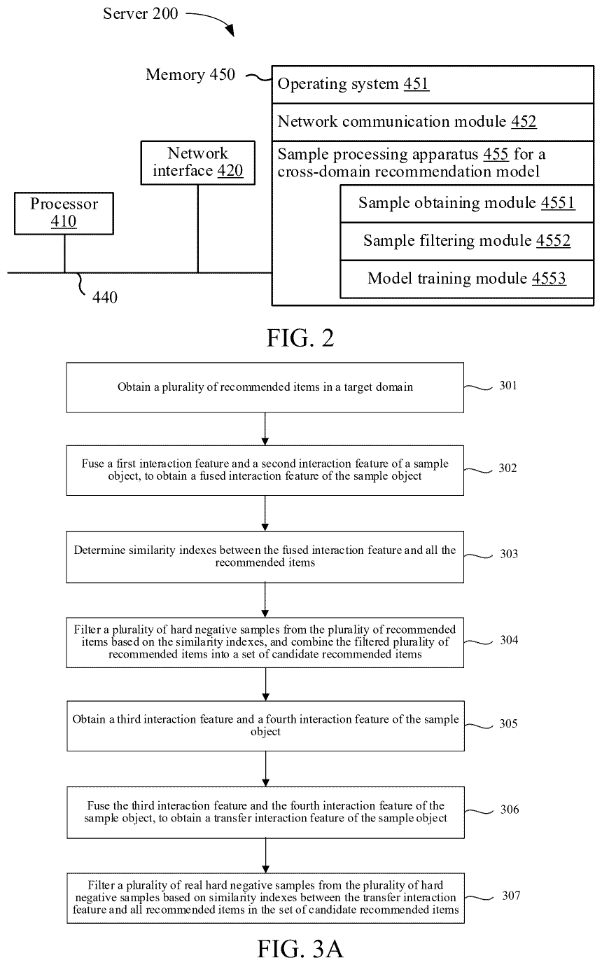

FIG. 2 is a schematic structural diagram of an electronic device according to an aspect of this disclosure. The electronic device shown in FIG. 2 is the server in FIG. 1. The server 200 includes at least one processor 410 (e.g., processing circuitry), a memory 450 (e.g., a non-transitory computer-readable storage medium), and at least one network interface 420. Components in the server 200 are coupled together by a bus system 440. The bus system 440 is configured to implement connection and communication between the components. In addition to a data bus, the bus system 440 also includes a power supply bus, a control bus, and a status signal bus. However, for clarity, various buses are marked as the bus system 440 in FIG. 2.

The processor 410 may be an integrated circuit chip with a signal processing capability, for example, a general purpose processor, a digital signal processor (DSP) or another programmable logic device, a discrete gate or a transistor logic device, or a discrete hardware component, where the general purpose processor may be a microprocessor or any conventional processor.

The memory 450 may be a removable memory, an irremovable memory, or a combination thereof. Example hardware devices include a solid-state memory, a hard disk drive, an optical disc driver, or the like. The memory 450 in some aspects includes one or more storage devices that are physically located away from the processor 410.

The memory 450 may include a volatile memory or a non-volatile memory, or may include both the volatile memory and the non-volatile memory. The non-volatile memory may be a read-only memory (ROM). The volatile memory may be a random access memory (RAM). The memory 450 described in aspects of this disclosure is intended to include memories of any other suitable types.

In some aspects, the memory 450 may store data to support various operations. Examples of the data include programs, modules, and data structures, or a subset or a superset thereof, which are illustrated below.

An operating system 451 includes system programs configured to process various basic system services and execute hardware-related tasks, for example, a framework layer, a core library layer, and a driver layer, for implementing various basic services and processing hardware-based tasks.

A network communication module 452 is configured to reach another electronic device through one or more (wired or wireless) network interfaces 420. Example network interfaces 420 include: Bluetooth, Wi-Fi, a universal serial bus (USB), and the like.

In some aspects, the apparatus provided in aspects of this disclosure may be implemented by software. FIG. 2 shows a sample processing apparatus 455 for a CDR model stored in the memory 450. The sample processing apparatus 455 for a CDR model may be software in a form of a program and a plug-in, and includes the following software modules: a sample obtaining module 4551 and a sample filtering module 4552. The modules are logical and may be combined in different manners or further split based on to-be-implemented functions. In FIG. 2, all the foregoing modules are shown at a time for convenience of expression, but it is not to be deemed that the sample processing apparatus 455 for a CDR model excludes the implementation that can include only the model training module 4553. Functions of modules are described below.

The sample processing method for a CDR model provided in aspects of this disclosure is described in combination with example applications and implementations of the terminal provided in aspects of this disclosure.

The sample processing method for a CDR model provided in aspects of this disclosure is described below. As stated above, an electronic device that implements the sample processing method for a CDR model in aspects of this disclosure may be a terminal, a server, or a combination thereof. Therefore, an execution subject of the operations is not repeatedly explained below.

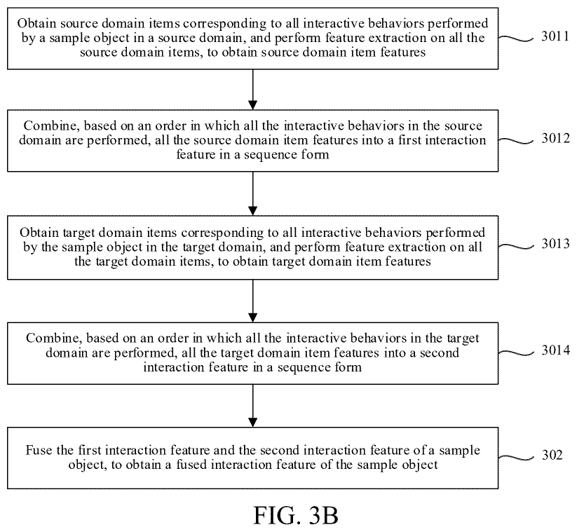

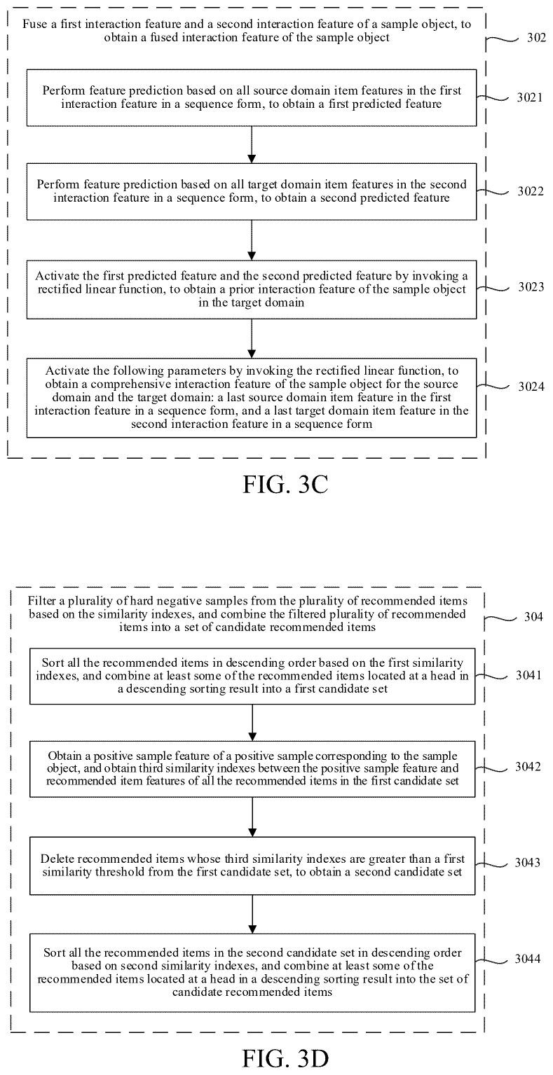

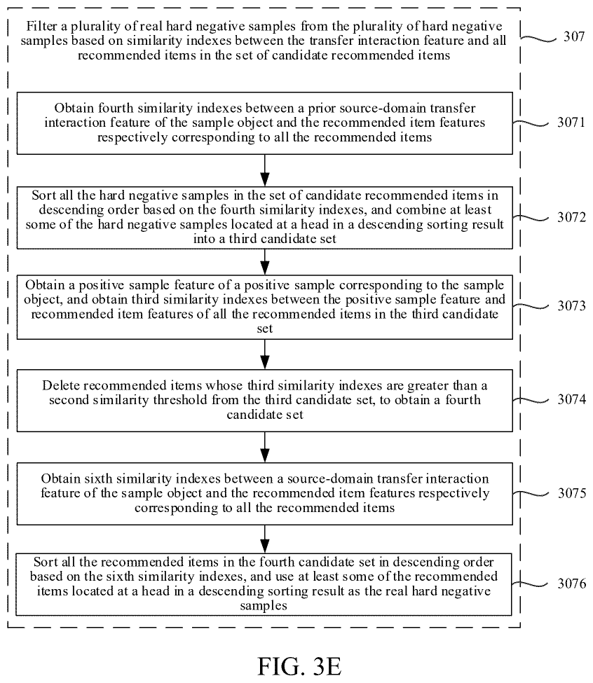

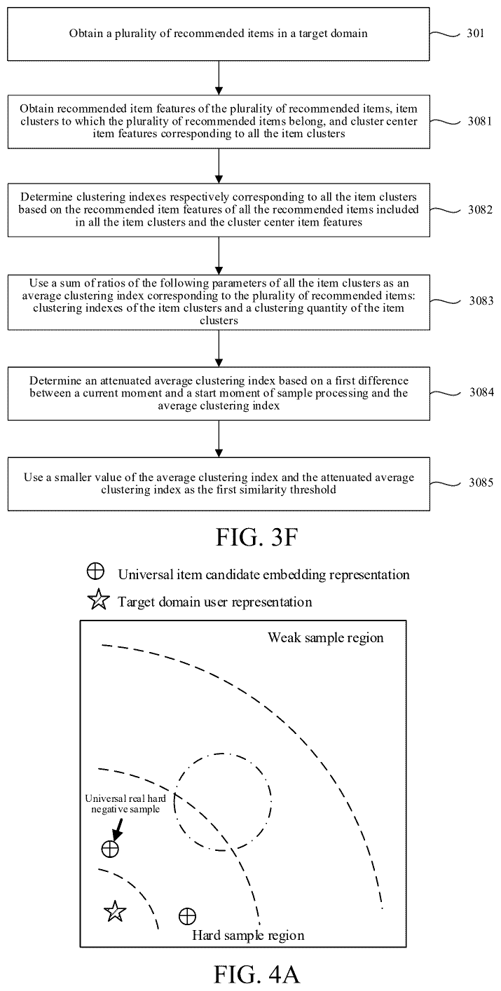

FIG. 3A is a first schematic flowchart of a sample processing method for a CDR model according to an aspect of this disclosure. Description is provided with reference to operations shown in FIG. 3A.

Operation 301: Obtain a plurality of recommended items in a target domain. For example, a plurality of recommended items in a target domain is obtained.

The recommended item is configured for recommendation to a sample object.

A domain refers to a range or region or refers to a scope of academic thoughts or social activities. In aspects of this disclosure, a domain includes any type of domain in which information recommendation can be performed. The recommended item is, for example, an article. A type of the article includes an actual article such as food and clothing and an advertisement of a virtual article such as a game and a game prop. The recommended item may also be information such as an advertisement, news, and music. The sample object may be a user.

In some aspects, FIG. 3B is a second schematic flowchart of a sample processing method for a CDR model according to an aspect of this disclosure. Before operation 302, operation 3011 to operation 3014 in FIG. 3B are performed, and are described below in detail.

Operation 3011: Obtain source domain items corresponding to all interactive behaviors performed by a sample object in a source domain, and perform feature extraction on all the source domain items, to obtain source domain item features. For example, source domain items corresponding to interaction behaviors performed by the sample object in the source domain are obtained.

For example, the interactive behaviors include clicking, browsing, forwarding, and commenting on an item, and purchasing a product corresponding to the item. Feature extraction is performed, through a convolutional neural network or a sequence encoder, on all the source domain items with which a user interacts, to obtain source domain item features. The i^{th} source domain item feature is represented by

$${v}_{i}^{S} ,$$

S denoting a source domain (source).

Operation 3012: Combine, based on an order in which all the interactive behaviors in the source domain are performed, all the source domain item features into a first interaction feature in a sequence form. For example, based on a temporal order of the interaction behaviors in the source domain, the source domain item features are combined into the first interaction feature in sequence form.

For example, when a user logs in to a corresponding application by using an account, and performs interactive behaviors in the application, the application automatically records execution times of all the interactive behaviors. A terminal device uploads the execution times of all the interactive behaviors to a server. The server obtains the execution times of all the interactive behaviors, and combines, based on a chronological order of all the interactive behaviors, source domain item features corresponding to all the interactive behaviors into a sequence, to obtain a first interaction feature

$${S}^{S} = \{ {v}_{1}^{S} , {v}_{2}^{S} , … , {v}_{p}^{S} \}$$

in a sequence form, p being a quantity of interactive behaviors in the source domain.

Operation 3013: Obtain target domain items respectively corresponding to all interactive behaviors performed by the sample object in the target domain, and perform feature extraction on all the target domain items, to obtain target domain item features. For example, target domain items corresponding to interaction behaviors performed by the sample object in the target domain are obtained. Feature extraction is performed on the target domain items to obtain target domain item features.

For example, similar to the source domain, details of a feature extraction process in the target domain are not described herein again. The j^{th} target domain item feature is represented by

$${v}_{j}^{T} ,$$

T denoting a target domain (target).

Operation 3014: Combine, based on an order in which all the interactive behaviors in the target domain are performed, all the target domain item features into a second interaction feature in a sequence form. For example, based on a temporal order of the interaction behaviors in the target domain, the target domain item features are combined into the second interaction feature in sequence form.

For example, execution times of all the interactive behaviors are obtained, and all the target domain item features are combined into a sequence based on a chronological order, to obtain a second interaction feature

$${S}^{T} = \{ {v}_{1}^{T} , {v}_{2}^{T} , … , {v}_{q}^{T} \}$$

in a sequence form, q being a quantity of interactive behaviors in the target domain. A quantity of interactive behaviors in the target domain may be the same as or different from a quantity of interactive behaviors in the source domain.

In this aspect of this disclosure, item features corresponding to the interactive behaviors of the object are obtained as an interaction feature of the object, and the interaction feature is represented by the item features, so that accuracy of obtaining a recommended item based on the interaction feature can be improved. In addition, compared with a manner of converting object information into object features, it saves computing resources required for obtaining similarities between an interaction feature and item features.

Reference is still made to FIG. 3A. Operation 302: Fuse the first interaction feature and the second interaction feature of the sample object, to obtain a fused interaction feature of the sample object. For example, a first interaction feature of a sample object in a source domain is fused with a second interaction feature of the sample object in the target domain to obtain a fused interaction feature of the sample object.

For example, the first interaction feature is an interaction feature of the sample object in the source domain, and the second interaction feature is an interaction feature of the sample object in the target domain.

In some aspects, the fused interaction feature includes: a prior interaction feature of the sample object in the target domain and a comprehensive interaction feature of the sample object for the source domain and the target domain. The comprehensive interaction feature is configured to represent features of interactive behaviors of the user in the target domain and the source domain. A prior interactive behavior is an interactive behavior that the user may perform, and a prior interaction feature is an interaction feature of a behavior that the user may perform.

FIG. 3C is a third schematic flowchart of a sample processing method for a CDR model according to an aspect of this disclosure. Operation 302 may be implemented through operation 3021 to operation 3024 in FIG. 3C. Details are described below.

Operation 3021: Perform feature prediction based on all source domain item features in the first interaction feature in a sequence form, to obtain a first predicted feature. For example, feature prediction is performed based on the source domain item features in the first interaction feature to obtain a first predicted feature indicating a predicted interaction behavior of the sample object in the source domain.

The first predicted feature is configured to represent a prior interactive behavior of the sample object in the source domain.

For example, using a target domain sequence S^{T} as an example, a source domain sequence can be extracted in a same manner. Details are not described again in this aspect of this disclosure. An input matrix

$${D}^{T} = [ {v}_{1}^{T} + {p}_{1}^{T} , {v}_{2}^{T} + {p}_{2}^{T} , … , {v}_{q}^{T} + {p}_{q}^{T} ]$$

∈ [symbol] is constructed, d being a size of an embedding feature,

$${v}_{q}^{T}$$

representing a learnable item index embedding feature, and

$${p}_{q}^{T}$$

representing a position embedding feature.

A sequence encoder (SASRec sequential recommendation (SR) algorithm) is invoked to linearly project the input matrix D^{T} to a query instruction Q^{T}, a key K^{T}, and a value V^{T}, and the query instruction Q^{T}, the key K^{T}, and the value V^{T} are substituted into an attention calculation method. The attention calculation method is defined as the following formula (1):

$${\hat{H}}^{T} = Attention ( {Q}^{T} , {K}^{T} , {V}^{T} ) = Soft max ( \frac{{{Q}^{T} ( {K}^{T} )}^{T}}{\sqrt{d}} ) {V}^{T} \qquad ( 1 )$$

Q^{T}=D^{T}W^{Q}, K^{T}=D^{T}W^{K}, and V^{T}=D^{T}W^{V}, W^{Q}, W^{K}, and W^{V} respectively represent different linear mapping layers. In this aspect of this disclosure, an implicit behavior matrix H^{T} in the target domain is further obtained through a point wise feed forward network. The point wise feed forward network includes two fully-connected layers, and there is a rectified linear unit (ReLU) activation function, referred to as an ReLU activation function below, between the two layers. A process of obtaining the implicit behavior matrix H^{T} is represented by the following formula (2):

$${H}^{T} = ReLU ( {\hat{H}}^{T} {w}_{1} + {b}_{1} ) {w}_{2} + {b}_{2} , {H}^{T} ∈ {ℝ}^{q \times d} \qquad ( 2 )$$

w₁ and w₂ represent weight matrices, and b₁ and b₂ are bias vectors. An implicit behavior matrix H^{S} of the user in the source domain is also constructed for a behavior interaction sequence S^{S} of the user in the source domain. The implicit behavior matrix H^{S} of the user in the source domain can be obtained according to the same principle as the formula (2).

A prior behavior matrix H̅^{S} in the source domain is obtained according to the principles of the formula (1) and the formula (2) in the foregoing text. Based on a feature corresponding to a last interactive behavior in a behavior interaction sequence S^{S} in the source domain and relationships between other features in the behavior interaction sequence S^{S} and a last feature in the behavior interaction sequence S^{S}, a first predicted feature of an interactive behavior that the user may perform after the last interactive behavior is predicted.

Operation 3022: Perform feature prediction based on all target domain item features in the second interaction feature in a sequence form, to obtain a second predicted feature. For example, feature prediction is performed based on the target domain item features in the second interaction feature to obtain a second predicted feature indicating a predicted interaction behavior of the sample object in the target domain.

The second predicted feature is configured to represent a prior interactive behavior of the sample object in the target domain.

A prior behavior matrix H̅^{T} in the target domain is obtained according to the principles of the formula (1) and the formula (2) in the foregoing text. Based on a feature corresponding to a last interactive behavior in a behavior interaction sequence S^{T} in the target domain and relationships between other features in the behavior interaction sequence S^{T} and the last feature in the behavior interaction sequence S^{T}, a second predicted feature of an interactive behavior that the user may perform after the last interactive behavior is predicted.

Operation 3023: Activate the first predicted feature and the second predicted feature by invoking a rectified linear function, to obtain the prior interaction feature of the sample object in the target domain. For example, a rectified linear function is invoked to activate the first predicted feature and the second predicted feature to obtain the prior interaction feature.

For example, a rectified linear function MLP^{f}(⋅) may be implemented through a two-layer fully-connected network of a leaky rectified linear unit (ReLU) activation function, hereinafter referred to LeakyReLU activation for short. The LeakyReLU activation is a variant of a ReLU activation function, and is configured to resolve a problem of “dead neurons” that a ReLU may encounter during neural network training. A prior interaction feature

$${\overline{u}}_{u}^{T}$$

of the user in the target domain is obtained through the following formula (3):

$${\overline{u}}_{u}^{T} = {MLP}^{f} ( {\overline{h}}_{u , p}^{s} ‖ {\overline{h}}_{u , p}^{T} ) \qquad ( 3 )$$

$${\overline{h}}_{u , p}^{S}$$

represents a prior behavior embedding feature (first predicted feature) of a last interactive behavior in a behavior sequence of a user u in the source domain, is a

$${\overline{h}}_{u , q}^{T}$$

is a prior behavior embedding feature (second predicted feature) of a last interactive behavior in a behavior sequence in the target domain, and MLP^{f}(⋅) represents a two-layer fully-connected network activated by a LeakyReLU, that is, the rectified linear function in the foregoing text.

Operation 3024: Activate the following parameters by invoking the rectified linear function, to obtain the comprehensive interaction feature of the sample object for the source domain and the target domain: a last source domain item feature in the first interaction feature in a sequence form, and a last target domain item feature in the second interaction feature in a sequence form. For example, the rectified linear function is invoked to activate a last source domain item feature in the first interaction feature and a last target domain item feature in the second interaction feature to obtain the comprehensive interaction feature. The prior interaction feature and the comprehensive interaction feature are combined to obtain the fused interaction feature.

For example, the last source domain item feature in the first interaction feature in a sequence form is a feature representing an interactive behavior closest to a current moment in the source domain, and the last target domain item feature in the second interaction feature in a sequence form is a feature representing an interactive behavior closest to the current moment in the target domain. Similar to the principle of operation 3021, features of interactive behaviors are represented as behavior matrices H^{S} and H^{T}, and based on latest interaction features

$${h}_{u}^{S} and {h}_{u}^{T}$$

in behavior sequences in the source domain and the target domain, the rectified linear function is invoked to generate the comprehensive interaction feature

$${u}_{u}^{T} = {MLP}^{f} ( {h}_{u}^{S} ‖ {h}_{u}^{T} ) .$$

In this aspect of this disclosure, interactive behaviors that may be performed by the user in the target domain and the source domain are predicted, features of the interactive behaviors that may be performed are fused with features of interactive behaviors that have been performed, to increase an amount of information included in features used as a recommendation basis, and a fused interaction feature is used as a basis for determining similarities between the fused interaction feature and recommended items, so that training samples of the CDR model can be optimized, thereby improving the accuracy of CDR.

Reference is still made to FIG. 3A. Operation 303: Determine similarity indexes between the fused interaction feature and all the recommended items. For example, similarity scores between the fused interaction feature and each of the plurality of recommended items are determined.

In some aspects, operation 303 may be implemented in the following manner: obtaining first similarity indexes between the prior interaction feature of the sample object in the target domain and recommended item features respectively corresponding to all the recommended items; and obtaining second similarity indexes between the comprehensive interaction feature of the sample object for the source domain and the target domain and the recommended item features respectively corresponding to all the recommended items.

For example, the prior interaction feature of the sample object in the target domain is respectively multiplied by recommended item features respectively corresponding to all the recommended items, to obtain first similarity indexes corresponding to all the recommended items, and combine the first similarity indexes into a sequence

$${s}_{u}^{T} = [ {\overline{u}}_{u}^{T} {v}_{1}^{T} , … , {\overline{u}}_{u}^{T} {v}_{n}^{T} ] . {u}_{u}^{T} {v}_{1}^{T}$$

is a first similarity index between the prior interaction feature

$${\overline{u}}_{u}^{T}$$

of the sample object in the target domain and an item feature

$${v}_{1}^{T}$$

of a first item in the target domain. The comprehensive interaction feature of the sample object is respectively multiplied by recommended item features respectively corresponding to all the recommended items, to obtain second similarity indexes respectively corresponding to all the recommended items.

In some aspects, the similarity index may alternatively be a cosine similarity between features in a vector form.

Operation 304: Filter a plurality of HNSs from the plurality of recommended items based on the similarity indexes, and combine the filtered plurality of recommended items into a set of candidate recommended items. For example, a plurality of hard negative samples (HNSs) is filtered from the plurality of recommended items based on the similarity scores. The plurality of HNSs is combined into a candidate recommended item set.

For example, the filtering manner includes, but is not limited to, sorting the similarity indexes, and selecting at least some of the similarity indexes sorted in descending order as HNSs. Compared with a positive sample, an HNS is an NS that is difficult to distinguish or classify. For ease of understanding, an example is provided below for description. In a CDR scenario, an HNS is an NS that is difficult to distinguish or classify because a similarity between a related feature (for example, an interactive effect and an object feature) of the NS in the recommended items and a related feature of the object is higher than a threshold.

In some aspects, reference is made to FIG. 3D. FIG. 3D is a fourth schematic flowchart of a sample processing method for a CDR model according to an aspect of this disclosure. Operation 304 may be implemented through operation 3041 to operation 3044 in FIG. 3D. Details are described below.

Operation 3041: Sort all the recommended items in descending order based on the first similarity indexes, and combine at least some of the recommended items located at a head in a descending sorting result into a first candidate set. For example, the plurality of recommended items is sorted in descending order based on the first similarity scores. A portion of the sorted recommended items is selected to form a first candidate set.

For example, a preset quantity of recommended items at a head in a descending sorting result are evenly sampled, and sampled recommended items are combined into a first candidate set.

Operation 3042: Obtain a positive sample feature of a positive sample corresponding to the sample object, and obtain third similarity indexes between the positive sample feature and recommended item features of all the recommended items in the first candidate set. For example, a positive sample feature of a positive sample corresponding to the sample object is obtained. Third similarity scores between the positive sample feature and recommended item features of each of the recommended items in the first candidate set are obtained.

For example, in this aspect of this disclosure, the positive sample is a preconfigured recommended item belonging to a positive sample type. The positive sample feature of the positive sample is preconfigured. The third similarity indexes of all the recommended items may be obtained in the following manner: obtaining products of the positive sample feature and the recommended item features of the recommended items, and using the products as third similarity indexes.

Operation 3043: Delete recommended items whose third similarity indexes are greater than a first similarity threshold from the first candidate set, to obtain a second candidate set. For example, from the first candidate set, the recommended items having third similarity scores greater than a first similarity threshold are removed to obtain a second candidate set.

For example, the first similarity threshold may be preconfigured, or may dynamically change based on a difference between a current moment and a start moment of sample processing.

In some aspects, reference is made to FIG. 3F. FIG. 3F is a sixth schematic flowchart of a sample processing method for a CDR model according to an aspect of this disclosure. After operation 301, operation 3081 to operation 3085 in FIG. 3F are performed, to obtain a first similarity threshold.

Operation 3081: Obtain recommended item features of the plurality of recommended items, item clusters to which the plurality of recommended items belong, and cluster center item features corresponding to all the item clusters. For example, item clusters from the plurality of recommended items are identified. Cluster center item features corresponding to the item clusters are obtained.

For example, in recommended item features V^{T} of the plurality of recommended items, an item cluster [symbol] and a corresponding cluster center

$${Φ}^{I} = [ {ϕ}_{1}^{I} , {ϕ}_{2}^{I} , … , {ϕ}_{{k}_{i}}^{I} ]$$

∈ [symbol] (kᵢ is a pre-defined clustering quantity of item clusters) are generated by using a K-means clustering algorithm,

$${ϕ}_{{k}_{i}}^{I}$$

being a cluster center item feature of an item cluster

$${ℛ}_{k}^{l}$$

whose index is k.

Operation 3082: Determine clustering indexes respectively corresponding to all the item clusters based on the recommended item features of all the recommended items included in all the item clusters and the cluster center item features. For example, a clustering index for each item cluster is determined based on the recommended item features of the recommended items within the respective item cluster and the cluster center item feature of the respective item cluster.

For example, for each item cluster, a clustering index corresponding to the item cluster is determined by performing weighted summation on products between all the recommended item features of the item cluster and the cluster center item feature.

Operation 3082 may be implemented in the following manner: performing the following processing for each of the item clusters: obtaining first products

$${( {v}^{T} )}^{⊤} {ϕ}_{k}^{l}$$

between transposes (v^{T})^{τ} of all the recommended item features in the item cluster and a cluster center item feature

$${ϕ}_{k}^{l} ;$$

respectively obtaining second ratios of all the first products

$${( {v}^{T} )}^{⊤} {ϕ}_{k}^{l}$$

to a quantity of recommended items in the item cluster; and using a sum of the second ratios as a clustering index of the item cluster. Operation 3082 may be represented as the following formula (4):

$${s}_{{k}_{i}}^{l} = \sum CalScore ( {V}_{k}^{l} , {ϕ}_{k}^{l} ) / len ( {𝒞}_{k}^{l} ) = {\sum }_{v ∈ {𝒞}_{k}^{l}} {( {v}^{T} )}^{⊤} {ϕ}_{k}^{l} / len ( {𝒞}_{k}^{l} ) \qquad ( 4 )$$

$${s}_{{k}_{i}}^{l}$$

is a clustering index of an item cluster i.

Operation 3083: Use a sum of ratios of the following parameters of all the item clusters as an average clustering index corresponding to the plurality of recommended items: clustering indexes of the item clusters and a clustering quantity of the item clusters. For example, an average clustering index is calculated as a sum of ratios. Each ratio includes the clustering index of a respective item cluster divided by a total number of the item clusters.

For example, if a ratio between the clustering index of the item cluster and the clustering quantity of the item cluster is represented as

$${s}_{t}^{l} / {k}_{i} ,$$

an average clustering index is

$${s}_{c} = {\sum }_{{s}_{t}^{l} ∈ {S}^{l}} {s}_{t}^{l} / {k}_{i} .$$

Operation 3084: Determine an attenuated average clustering index based on a first difference between a current moment and a start moment of sample processing and the average clustering index. For example, an attenuated average clustering index is determined based on a first difference between a current time and a sample processing time and the average clustering index.

For example, operation 3084 may be implemented in the following manner: obtaining a preconfigured periodic attenuation ratio t, an initial filtering index X, and a quantity ψ of cycles for sample processing; obtaining a third ratio

$$\frac{{s}_{c}}{χ}$$

between the average clustering index s_{c} and the initial filtering index χ; assuming that the current moment is e, and the start moment is μ, using a ratio between the first difference (e−μ) and the quantity ψ of cycles as an

$$\frac{( e - μ )}{ψ} ,$$

and using the periodic attenuation ratio as a base τ, to form a time attenuation parameter

$${τ}^{⌈ \frac{( e - μ )}{ψ} ⌉} ;$$

and using a product of the third ratio and the time attenuation parameter as the attenuated average clustering index

$$\frac{{s}_{c}}{χ} * {τ}^{⌈ \frac{( e - μ )}{ψ} ⌉} .$$

Operation 3085: Use a smaller value of the average clustering index and the attenuated average clustering index as the first similarity threshold. For example, a smaller value between the average clustering index and the attenuated average clustering index is selected as the first similarity threshold.

For example, the average clustering index and the attenuated average clustering index are compared, and a smaller value thereof is used as the first similarity threshold.

In some aspects, the start moment is set to a specific moment in the future of the current moment. In this case, the first similarity threshold may be infinite. Operation 3081 to operation 3085 are also applicable to obtaining a second similarity threshold.

In this aspect of this disclosure, a similarity threshold is dynamically obtained, so that the similarity threshold can be matched based on a related feature in an application scenario, thereby improving accuracy of obtaining the similarity threshold, and further improving accuracy of filtering recommended items based on the similarity threshold.

Reference is still made to FIG. 3D. Operation 3044: Sort all the recommended items in the second candidate set in descending order based on second similarity indexes, and combine at least some of the recommended items located at a head in a descending sorting result into the set of candidate recommended items. For example, the recommended items in the second candidate set are sorted in descending order based on the second similarity scores. A portion of the sorted recommended items in the second candidate set is selected as the plurality of HNSs to form the candidate recommended item set.

For example, the second similarity indexes are products of the comprehensive interaction feature and recommended item features respectively corresponding to all the recommended items. For example, a second similarity index of an item i in the target domain may be obtained in the following manner: multiplying a comprehensive interaction feature

$${u}_{u}^{T}$$

by an item feature

$${v}_{i}^{T}$$

of the item i in the target domain, to obtain the second similarity index of the item i in the target domain.

Operation 305: Obtain a third interaction feature and a fourth interaction feature of the sample object.

For example, the third interaction feature is an interaction feature that is of an interactive behavior of the sample object in the source domain and that is time-effective in the source domain, and the fourth interaction feature is a cluster center of the second interaction features of a plurality of sample objects in the target domain. The cluster center refers to an average eigenvalue of each cluster during cluster analysis. Different cluster centers are selected in different clustering algorithms. For example, in a K-means clustering algorithm, a cluster center is determined by calculating distances between data points and the cluster center. In another clustering algorithm, such as hierarchical clustering or density-based clustering, a manner of determining a cluster center is different from that of the K-means clustering algorithm.

In some aspects, operation 305 may be implemented in the following manner: using a last source domain item feature in the first interaction feature in a sequence form as the third interaction feature, the last source domain item feature being configured to represent an interactive behavior finally performed by the sample object in the source domain, the third interaction feature being represented as

$${h}_{u}^{S} ,$$

u referring to a user, and S referring to a source domain; obtaining first ratios of the following parameters respectively corresponding to a plurality of sample objects: the second predicted feature of the sample object in the target domain and a quantity of objects in an object cluster to which the sample objects belong; and adding up the first ratios to obtain the fourth interaction feature.

The quantity of objects in the object cluster may be obtained by using a len ( ) function. The len ( ) function is a function configured for returning a length or a quantity of elements of an object. The object cluster is a user cluster, and is represented as a user cluster [symbol] . The second predicted feature of the sample object in the target domain is a prior behavior matrix H̅^{T} of the user in the target domain. The first ratio may be represented as

$$( {\overline{h}}_{u , q}^{T} ) / len ( {𝒞}_{k}^{U} ) .$$

Further, a formula

$${ϕ}_{k}^{U}$$

for obtaining the fourth interaction feature by adding up all the first ratios is the following formula (5):

$${ϕ}_{k}^{U} = {\sum }_{u ∈ {𝒞}_{k}^{U}} \frac{{\overline{h}}_{u , q}^{T}}{len ( {𝒞}_{k}^{U} )} \qquad ( 5 )$$

The len ( ) function is configured for quickly obtaining a quantity of elements of a sequence (for example, list, tuple, or str) and may be configured for checking a length of a character string, a list, a tuple, a dictionary, or a set. The fourth interaction feature is configured to represent a center of gravity feature of each user cluster. k represents an index of a user cluster to which a user u belongs.

In some aspects, the transfer interaction feature includes: a prior source-domain transfer interaction feature of the sample object and a source-domain transfer interaction feature of the sample object. The source-domain transfer interaction feature is a feature used for representing a change in a process of transfer of an interactive behavior of an object from the source domain to the target domain. The prior source-domain transfer interaction feature is a feature used for representing a change in a process of transfer of an interactive behavior of an object that is not performed yet from the source domain to the target domain.

Operation 306: Fuse the third interaction feature and the fourth interaction feature of the sample object, to obtain a transfer interaction feature of the sample object. For example, a third interaction feature is fused with a fourth interaction feature to obtain a transfer interaction feature of the sample object. The third interaction feature indicates time-sensitive interaction behavior of the sample object in the source domain. The fourth interaction feature indicates a cluster center of the second interaction feature.

Operation 306 may be implemented in the following manner: activating the first predicted feature and the fourth interaction feature of the sample object by invoking the rectified linear function, to obtain the prior source-domain transfer interaction feature of the sample object; and activating the third interaction feature and the fourth interaction feature by invoking the rectified linear function, to obtain the source-domain transfer interaction feature of the sample object.

For example, the rectified linear function is invoked based on a first predicted feature

$${\overline{h}}_{u , p}^{S}$$

and a fourth interaction feature

$${ϕ}_{k}^{U}$$

for calculation, to obtain a prior source-domain transfer interaction feature

$${\overline{u}}_{u}^{S} = {MLP}^{f} ( {\overline{h}}_{u , p}^{S} ‖ {ϕ}_{k}^{U} ) .$$

The rectified linear function is invoked based on a third interaction feature

$${h}_{u}^{S}$$

and the fourth interaction feature

$${ϕ}_{k}^{U}$$

for calculation, to obtain a source-domain transfer interaction feature

$${u}_{u}^{S} = {MLP}^{f} ( {h}_{u}^{S} ‖ {ϕ}_{k}^{U} ) .$$

Operation 307: Filter a plurality of RHNSs from the plurality of HNSs based on similarity indexes between the transfer interaction feature and all recommended items in the set of candidate recommended items. For example, a plurality of real hard negative samples (RHNSs) is filtered from the plurality of HNSs based on similarity scores between the transfer interaction feature and each of the plurality of HNSs in the candidate recommended item set. The plurality of RHNSs is used to train the CDR model.

For example, the plurality of RHNSs are configured for training the CDR model. The filtering manner includes, but is not limited to, sorting the similarity indexes, and selecting at least some of the similarity indexes sorted in descending order as RHNSs

In some aspects, reference is made to FIG. 3E. FIG. 3E is a fifth schematic flowchart of a sample processing method for a CDR model according to an aspect of this disclosure. Operation 307 may be implemented through operation 3071 to operation 3076 in FIG. 3E. Details are described below.

Operation 3071: Obtain fourth similarity indexes between the prior source-domain transfer interaction feature of the sample object and the recommended item features respectively corresponding to all the recommended items. For example, fourth similarity scores between the prior source-domain transfer interaction feature of the sample object and recommended item features of each of the plurality of HNSs in the candidate recommended item set are obtained.

For example, the following processing is performed for all the recommended items: multiplying the prior source-domain transfer interaction feature by the recommended item features, to obtain the fourth similarity indexes of the recommended items. The fourth similarity index is a product between the matrices.

Operation 3072: Sort all the HNSs in the set of candidate recommended items in descending order based on the fourth similarity indexes, and combine at least some of the HNSs located at a head in a descending sorting result into a third candidate set. For example, the plurality of HNSs in the candidate recommended item set in descending order is sorted based on the fourth similarity scores. A portion of the sorted HNSs is selected to form a third candidate set.

For example, a preset quantity of HNSs at a head in a descending sorting result are evenly sampled, and sampled HNSs are combined into a third candidate set.

Operation 3073: Obtain a positive sample feature of a positive sample corresponding to the sample object, and obtain third similarity indexes between the positive sample feature and recommended item features of all the recommended items in the third candidate set. For example, a positive sample feature of a positive sample corresponding to the sample object is obtained. Third similarity scores between the positive sample feature and the recommended item features of each of the recommended items in the third candidate set are obtained.

For example, the principle of operation 3073 is the same as that of operation 3043. Details are not described herein again.

Operation 3074: Delete recommended items whose third similarity indexes are greater than a second similarity threshold from the third candidate set, to obtain a fourth candidate set. For example, from the third candidate set, the recommended items having third similarity scores greater than a second similarity threshold are removed to obtain a fourth candidate set.

For example, for a manner of obtaining the second similarity threshold, reference may be made to operation 3044, and details are not described herein again. In the field of sample enhancement processing, a similarity between an FHNS and a positive sample is higher than that between an RHNS and a positive sample. A higher similarity between an HNS and a positive sample indicates a higher probability of an FHNS. Samples whose similarity indexes are greater than a similarity threshold are deleted by comparing similarity indexes with a similarity threshold, so that there are fewer FHNSs in the remaining samples, thereby improving accuracy of obtaining an RHNS.

Operation 3075: Obtain sixth similarity indexes between the source-domain transfer interaction feature of the sample object and the recommended item features respectively corresponding to all the recommended items. For example, sixth similarity scores between the source-domain transfer interaction feature of the sample object and the recommended item features of each of the recommended items in the fourth candidate set are obtained.

For example, the following processing is performed for all the recommended items: obtaining products of the source-domain transfer interaction feature of the sample object and the recommended item features, and using the products as the sixth similarity indexes.

Operation 3076: Sort all the recommended items in the fourth candidate set in descending order based on the sixth similarity indexes, and use at least some of the recommended items located at a head in a descending sorting result as the RHNSs. For example, the recommended items in the fourth candidate set in descending order are sorted. based on the sixth similarity scores. A portion of the sorted recommended items in the fourth candidate set is selected as the plurality of RHNSs.

For example, a preset quantity of recommended items at a head in a descending sorting result are evenly sampled, and sampled recommended items are used as RHNSs.

In this aspect of this disclosure, FHNSs included in finally obtained RHNSs are reduced through a plurality of rounds of filtering, and further, the CDR model can be trained based on the RHNSs, thereby improving accuracy of recommendation by the model in the target domain.

In some aspects, after operation 307, the CDR model is trained in the following manner: obtaining a training sample set, the training sample set including: a sample interaction feature of a sample object, a plurality of sample recommended items as positive samples, and a plurality of sample recommended items as NSs, the NSs including a preconfigured quantity of RHNSs, sample tag values of the NSs being 0, and sample tag values of the positive samples being 1; invoking an initialized CDR model based on the training sample set to perform recommendation result prediction, to obtain recommendation results respectively corresponding to all the sample recommended items; determining a loss function of the CDR model based on differences between the recommendation results respectively corresponding to all the sample recommended items and the sample tag values; and updating a parameter of the initialized CDR model based on the loss function, to obtain the trained CDR model.

For example, the loss function may be obtained in the following manner: performing the following processing for all the sample recommended items: multiplying a transpose matrix (u^{T})^{T} of an interaction feature matrix of the sample object by matrices

$${d}_{q + 1}^{T}$$

of the recommended item features of all the sample recommended items, to obtain predicted probabilities

$${\hat{y}}^{T} = CalScore ( {u}^{T} , {v}_{q + 1}^{T} ) = {( {u}^{T} )}^{T} {d}_{q + 1}^{T}$$

of the sample recommended items, u^{T} being an interaction feature in the target domain; obtaining second products of logarithms

$$log {\hat{y}}_{u , d}^{T}$$

of the predicted probabilities and the sample tag values

$${y}_{u , d}^{T}$$

of the sample recommended items, the second product being represented as

$${y}_{u , d}^{T} log {\hat{y}}_{u , d}^{T} ;$$

obtaining a second difference

$$( 1 - {y}_{u , d}^{T} )$$

between 1 and the sample tag value, and obtaining a logarithm log

$$( 1 - {\hat{y}}_{u , d}^{T} )$$

of a third difference between 1 and the predicted probabilities; multiplying the second differences by the logarithms of the third differences, to obtain third products, the third product being represented as

$$( 1 - {y}_{u , d}^{T} ) log ( 1 - {\hat{y}}_{u , d}^{T} ) ;$$

using sums of the second products and the third products as sub-losses of the sample recommended items, the sub-loss being represented as

$$[ {y}_{u , d}^{T} log {\hat{y}}_{u , d}^{T} + ( 1 - {y}_{u , d}^{T} ) log ( 1 - {\hat{y}}_{u , d}^{T} ) ] ;$$

and adding up all the sub-losses to obtain the loss function of the CDR model. The loss function L is represented by the following formula (9):

$$ℒ = - {\sum }_{( u , d ) ∈ {R}^{T}} [ {y}_{u , d}^{T} log {\hat{y}}_{u , d}^{T} + ( 1 - {y}_{u , d}^{T} ) log ( 1 - {\hat{y}}_{u , d}^{T} ) ] \qquad ( 9 )$$

R^{T} is a training set of the target domain,

$${y}_{u , d}^{T} = 1 and {\hat{y}}_{u , d}^{T} = 0$$

respectively represent a positive sample and a corresponding NS, and

$${\hat{y}}_{u , d}^{T}$$

represents predicted probabilities of (u, d).

The CDR model obtained through training in this aspect of this disclosure can be applied to the following scenarios: 1. Product recommendation is performed to a user based on video content favored by the user. For example, the user often browses videos of a specific subject on a video platform. Based on the sample processing method for a CDR model provided in this aspect of this disclosure, a training sample set is determined based on interaction features collected on a video platform and to-be-recommended items collected on a shopping platform, the CDR model is trained based on the training sample set, and the trained CDR model is invoked based on video content browsed by the user on a video platform, to recommend corresponding products on the shopping platform to the user. 2. Video recommendation is performed to a user based on music favored by the user. For example, a trained CDR model is invoked based on songs that a user listens to in an audio application, to recommend short videos on a video platform to the user. Assuming that the user listens to songs in a rock-and-roll style in the audio application, a soundtrack of a video recommended on the video platform may be in a corresponding rock-and-roll style.

In this aspect of this disclosure, a plurality of recommended items are initially filtered based on a fused interaction feature of a sample object between different domains, to obtain a set of candidate recommended items formed by combining HNSs. The set of candidate recommended items is filtered based on an interaction feature of a sample object transferred between different domains, to obtain RHNSs for training the CDR model. Through a plurality rounds of filtering, accuracy of RHNSs obtained through filtering is improved. The RHNSs obtained through filtering are configured for training the CDR model, which can improve accuracy of information recommendation of the model in the target domain.

An example application of the sample processing method for a CDR model according to this aspect of this disclosure in an actual application scenario is described below.

The related technologies can be roughly classified into three categories of related research: CDR, cross-domain sequential recommendation (CDSR), and a negative sampling method in the recommendation field. CDR is one of the representative methods for alleviating the data sparsity problem in the recommendation field, and helps improve performance of a model in a target domain by overlapping auxiliary behaviors of a user from another domain. In a classic CDR algorithm, multi-task learning, alignment constraints, and contrastive learning are used to simulate cross-domain knowledge transfer. CDSR is a sub-field of CDR. For example, compared with related CDR, CDSR pays more attention to a multi-domain temporal behavior sequence of a user.

The related technologies mainly include CDR and a negative sampling method used in the recommendation field. Most related CDR methods focus on only feature-level cross-domain correlations of NSs randomly extracted from a target domain, and ignore cross-domain differences between the NSs at a sample level. Over-optimizing the randomly sampled NSs at the feature level may ignore source domain preferences of a user to some extent, possibly resulting in sub-optimal performance. Negative sampling methods used in the recommendation field are usually classified into static negative sampling strategies and hard negative sampling strategies based on whether a sampling probability provided by a negative sampling method is fixed. The static negative sampling strategies are usually performing negative sampling based on a fixed distribution probability, which makes it impossible to dynamically capture a preference change between a user and an item in a model training process. However, most hard negative sampling strategies are designed on CF tasks, and may not be directly transferred to a CDR task and play a role. In addition, the methods all avoid the FHNS problem by selecting parameters, which is unstable and uninterpretable for different data sets, and also makes it challenging to effectively explore and use HNSs.

This aspect of this disclosure provides an effective and simple universal RHNS sampling method for a CDR task. A universal RHNS sampler and a cross-domain RHNS sampler are provided under a CDR task, to filter out FHNSs from all HNSs and select RHNSs (RHNS). This may be implemented in the following manner: When two classes of samples are filtered, coarse-grained and fine-grained RHNS selectors are sequentially used, and FHNSs in the candidate set are filtered out by using an item (recommended content)-specific dynamic filter. For a special cross-domain setting, in aspects of this disclosure, a novel cross-domain RHNS filtering manner is further designed to alleviate negative information transfer that may exist during CDR information transfer, and FHNSs of different users under the special cross-domain setting are explored by using a user-specific dynamic filter, thereby improving performance of an related CDR model.

The sample processing method for a CDR model provided in aspects of this disclosure is significantly different from the related technologies: (1) Coarse-grained and fine-grained HNS selectors are designed in universal RHNS selectors to effectively search for RHNSs, and HNSs excessively similar to positive samples are dynamically filtered out by using an item (recommended content)-specific FHNS filter.

(2) A novel cross-domain NS filtering manner is provided in a cross-domain RHNS selector, to overcome an inherent problem of negative information transfer in CDR. That is, a user-specific dynamic FHNS filter is designed, and works together with coarse-grained and fine-grained HNS selectors, to improve cross-domain HNS filtering and optimization from the perspective of a user.

(3) Relative proportions of random NSs, RHNSs, and FHNSs in training samples are balanced during model training by using a curriculum learning framework.

(4) The sample processing method for a CDR model provided in aspects of this disclosure is irrelevant to a model type used in an actual application scenario, is easy to deploy, can be applied to different negative sampling methods, and can all bring stable improvements.

For ease of understanding the sample processing method for a CDR model provided in aspects of this disclosure, a relationship between an object and a sample in CDR is explained and described.

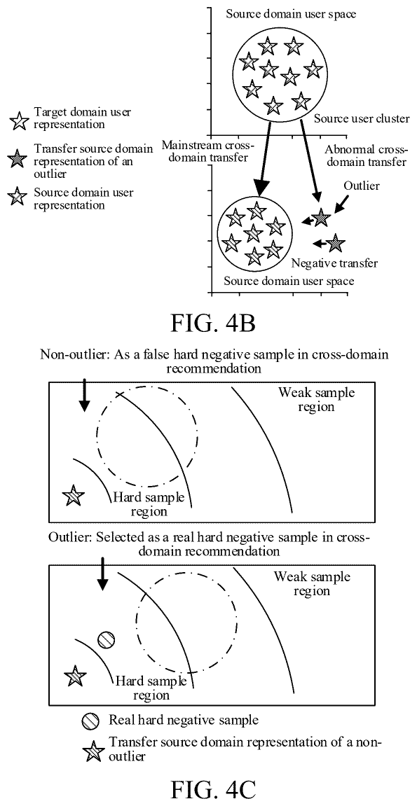

Reference is made to FIG. 4A. FIG. 4A is a schematic diagram of a first relationship between a feature and a sample according to an aspect of this disclosure. Universal FHNSs and cross-domain FHNSs are described under a CDR setting. A star and a circle respectively represent features of a user and an item. FIG. 4A shows that a universal FHNS is close to a positive sample.

Reference is made to FIG. 4B. FIG. 4B is a schematic diagram of a second relationship between a feature and a sample according to an aspect of this disclosure. Users deviating from mainstream cross-domain transfer (for example, there is no similarity between preferences of a user for different domains, for example, it is difficult to accurately recommend, based on a movie, a book subject favored by the user) are considered as outliers, and they are incorrectly affected by non-outliers. As shown by black arrows, stars represented by outliers are located outside a region in which non-outliers are located.

Reference is made to FIG. 4C. FIG. 4C is a schematic diagram of a third relationship between a feature and a sample according to an aspect of this disclosure. It can be learned from FIG. 4C that a cross-domain FHNS is related to a non-outlier in CDR.

For example, based on the foregoing relationships between a feature and a sample in the CDR field in FIG. 4A to FIG. 4C, in aspects of this disclosure, the cross-domain setting is analyzed, and three types of assumptions are provided: Assumption 1: An item (recommended content) similar to a positive sample is more likely to become an FHNS than another sample in CDR. Assumption 2: A sample having a hard similarity with a source domain feature of a user indicates a transfer preference of the user, and is more likely to be an FHNS of a non-outlier. Assumption 3: Introduction of all HNSs at the beginning of a training process may cause a calculation waste and sub-optimal performance.

According to a sample processing method provided in aspects of this disclosure, a universal RHNS selector and a cross-domain RHNS selector are used during sampling to improve CDR. For example, behavior sequence features of a source domain and a target domain are given. Universal RHNSs are sampled by using a universal RHNS selector, to obtain a universal candidate item set, and FHNSs that may exist in the universal candidate item set are eliminated by using an item-specific FHNS filter.

To further alleviate negative transfer (negative transfer is a hindering effect of one type of learning on another type of learning, and is presented in mutual impact of learning new and old knowledge and mastering former and later methods) that is inherent in CDR, in aspects of this disclosure, a cross-domain RHNS selector is configured to dynamically distinguish, by using user-specific and item-specific FHNS filters, outliers in a set of all users and FHNSs in a cross-domain candidate item set.

Sampling methods for the foregoing two domains (the source domain and the target domain) are both symmetrical, and are irrelevant to a model, so that the sample processing method for a CDR model provided in aspects of this disclosure can be easily transferred to CF and SR tasks.

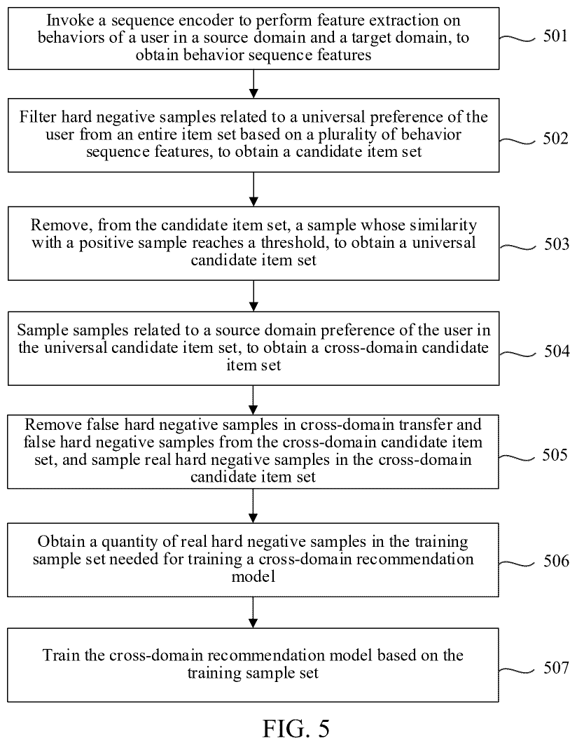

For example, the following explains and describes, with reference to the accompanying drawings, a sample processing method for a CDR model provided in an aspect of this disclosure. Reference is made to FIG. 5. FIG. 5 is a seventh schematic flowchart of a sample processing method for a CDR model according to an aspect of this disclosure. A server is used as an execution body, and is described with reference to operations in FIG. 5.

Operation 501: Invoke a sequence encoder to perform feature extraction on behaviors of a user in a source domain and a target domain, to obtain behavior sequence features.

A source domain behavior sequence

$${S}^{S} = \{ {v}_{1}^{S} , {v}_{2}^{S} , ⋯ , {v}_{p}^{S} \}$$

and a target domain behavior sequence

$${S}^{T} = \{ {v}_{1}^{T} , {v}_{2}^{T} , ⋯ , {v}_{p}^{T} \}$$

are respectively defined in the source domain and the target domain T.

$${v}_{i}^{S} and {v}_{j}^{T}$$

respectively represent quantities of behaviors of the user in the source domain and the target domain, and

$${v}_{i}^{S} and {v}_{j}^{T}$$

respectively represent behavior embeddings. Behavior sequences S^{S} and S^{T} are given. The RHNS framework attempts to recommend a next interaction item

$${v}_{p + 1}^{T}$$

of the user in the target domain to the user. The source domain behavior sequence is the first interaction feature in the foregoing text, and the target domain behavior sequence is the second interaction feature in the foregoing text.

In this aspect of this disclosure, the SR algorithm SASRec is used as a sequence encoder. Using a target domain sequence S^{T} as an example, a source domain sequence can be extracted in a same manner. Details are not described in this aspect of this disclosure. An input matrix

$${D}^{T} = [ {v}_{1}^{T} + {p}_{1}^{T} , {v}_{2}^{T} + {p}_{2}^{T} , … , {v}_{q}^{T} + {p}_{q}^{T} ]$$

∈ [symbol] is constructed, d being a size of an embedding feature,

$${v}_{q}^{T}$$

representing a learnable item index embedding feature, and

$${p}_{q}^{T}$$

representing a position embedding feature.

A sequence encoder is invoked. The sequence encoder invokes an SR algorithm (SASRec) to linearly project the input matrix D^{T} to a query instruction Q^{T}, a key K^{T}, and a value V^{T}, and the query instruction Q^{T}, the key K^{T}, and the value V^{T} are substituted into an attention calculation method. The attention calculation method defines the following formula (1):

$${\hat{H}}^{T} = Attention ( {Q}^{T} , {K}^{T} , {V}^{T} ) = Softmax ( \frac{{{Q}^{T} ( {K}^{T} )}^{T}}{\sqrt{d}} ) {V}^{T} \qquad ( 1 )$$

Q^{T}=D^{T}W^{Q}, K^{T}=D^{T}W^{K}, V^{T}=D^{T}W^{V}, We, W^{K}, and W^{V} respectively representing different linear mapping layers. In this aspect of this disclosure, an implicit behavior matrix H^{T} of the target domain is further obtained through a point wise feed forward network. The point wise feed forward network includes two fully-connected layers, and there is a ReLU activation function between the two layers. A process of obtaining the implicit behavior matrix H^{T} is represented by the following formula (2):

$${H}^{T} = ReLU ( {\hat{H}}^{T} {w}_{1} + {b}_{1} ) {w}_{2} + {b}_{2} , {H}^{T} ∈ {ℝ}^{q \times d} \qquad ( 2 )$$

w₁ and w₂ represent weight matrices, and b₁ and b₂ are bias vectors. An implicit behavior matrix H^{S} of the user in the source domain is also constructed for a behavior interaction sequence S^{S} of the user in the source domain. The implicit behavior matrix H^{S} of the user in the source domain can be obtained according to the same principle as the formula (2).

The first task for resolving the false negative problem is to distinguish FHNSs from RHNSs from an entire item set based on historical interaction information of a user. An aspect of this disclosure provides a universal RHNS selector to select universal RHNSs in CDR. For example, in this aspect of this disclosure, a candidate item set related to a universal preference of a user is obtained through coarse-grained RHNS selection, and items excessively similar to positive samples are removed from the candidate item set through fine-grained RHNS selection. A parameter used as a filtering index in a fine-grained filtering process is dynamic (related to assumption 1 above). This is described below in operation 502 and operation 503.

Operation 502: Filter HNSs related to a universal preference of the user from an entire item set based on a plurality of behavior sequence features, to obtain a candidate item set.

In the related art, hard negative sampling is usually to uniformly sample a fixed quantity of candidate item sets, and then dynamically select, from randomly extracted candidate item sets, an item having a highest score calculated by a recommendation model in a current state, as an HNS. However, such a method excessively relies on an appropriate quantity of candidate items. For example, an excessively small quantity of candidate items may cause randomness and unstable quality of HNSs, and an excessively large quantity of candidate items may greatly increase hardness of selected HNSs, resulting in an optimization bias of the model. In addition, the foregoing method further shows significant parameter changes in different data sets, and cannot achieve consistency improvement in all cases compared with a static negative sampling method.

In aspects of this disclosure, universal coarse-grained selection is performed on the entire item set, to sample item candidates related to the universal preference of the user in CDR.

For example, prior behavior matrices H̅^{S} and H̅^{T} of the source domain and the target domain are calculated by using the sequence encoder at a beginning of each period (a preset cycle). Based on the assumption that “the last behavior in the behavior sequence of the object includes his/her overall preference”, a prior interaction feature of a user u is generated, and finally, a prior interaction feature

$${\overline{u}}_{u}^{T}$$

of a user in the target domain is obtained by using the following formula (3):

$${\overline{u}}_{u}^{T} = {MLP}^{f} ( {\overline{h}}_{u , p}^{S} ‖ {\overline{h}}_{u , q}^{T} ) \qquad ( 3 )$$

$${\overline{h}}_{u , p}^{S}$$

represents a prior behavior embedding feature (first predicted feature) of a last interactive behavior in a behavior sequence of a user u in the source domain,

$${\overline{h}}_{u , q}^{T}$$

is a prior behavior embedding feature (second predicted feature) of a last interactive behavior in a behavior sequence in the target domain, and MLP^{f}(⋅) represents a two-layer fully-connected network activated by a LeakyReLU, that is, the rectified linear function in the foregoing text.

First similarity indexes are calculated for the prior interaction feature

$${\overline{u}}_{u}^{T}$$

of the user u and the learnable item embedding features

$${V}^{T} = [ {v}_{1}^{T} , {v}_{2}^{T} , … , {v}_{n}^{T} ]$$

∈ [symbol] , and the first similarity indexes are sorted in descending order. The calculation method is: obtaining products between item features in the learnable item embedding features and the prior interaction feature of the user in the target domain. A calculation result represented as a sequence is obtained as

$${s}_{u}^{T} = [ {\overline{u}}_{u}^{T} {v}_{1}^{T} , … , {\overline{u}}_{u}^{T} {v}_{n}^{T} ] .$$

All elements in the calculation result are first similarity indexes respectively corresponding to all items, and a fixed quantity of items are uniformly sampled from a top range with large first similarity indexes to construct a universal candidate item set

$${ℛ}_{u}^{T} .$$

According to this aspect of this disclosure, a universal candidate item set can be sampled based on prior knowledge of a universal preference of a user, thereby alleviating a problem of excessive randomness when a candidate item set is selected in a related method. In this aspect of this disclosure, the foregoing operations are performed only at the beginning of each period. Therefore, no excessive calculation costs are introduced. During online serving, time complexity (a quantity of times a statement in an algorithm is executed is referred to as a statement frequency or time frequency, and the time complexity is configured to describe a running time of the algorithm) that can be achieved through the KD-Tree (which is a tree data structure that stores instance points in a k-dimensional space for fast retrieval).

Operation 503: Remove, from the candidate item set, a sample whose similarity with a positive sample reaches a threshold, to obtain a universal candidate item set.

Compared with classic hard negative sampling that emphasizes “a higher score between a user and an item indicates a higher possibility of an FHNS”. The score may be a similarity index in this aspect of this disclosure. This aspect of this disclosure additionally provides an assumption: In CDR, an item similar to a positive sample is more likely to be an FHNS. This assumption is very intuitive. That is, if a user likes an item, for example, a role A, he/she may also like another similar item, for example, a role B and a role C that belong to a same series as the role A.

Based on the foregoing assumption, in this aspect of this disclosure, the candidate item set is adaptively filtered through fine-grained RHNS selection based on unsupervised clustering. For example, in this aspect of this disclosure, item cluster [symbol] and corresponding cluster centers

$${Φ}^{I} = [ {ϕ}_{1}^{I} , {ϕ}_{2}^{I} , … , {ϕ}_{{k}_{i}}^{I} ]$$

∈ [symbol] (kᵢ is a quantity of clusters of predefined item clusters) in item embedding features V^{T} are generated through the K-means clustering algorithm, and an average item clustering index

$${S}^{I} = [ {s}_{1}^{I} , {s}_{2}^{I} , … , {s}_{{k}_{i}}^{I} ]$$

calculated.

$${s}_{k}^{I}$$

represents similarity indexes between embedding features

$${V}_{k}^{I}$$

of all items in the cluster

$${ℛ}_{k}^{I}$$

indexed as k and weir corresponding cluster centers

$${ϕ}_{k}^{I} .$$

The clustering index

$${s}_{{k}_{i}}^{I}$$

of each item cluster can be defined as the following formula (4):

$${s}_{{k}_{i}}^{I} = \sum CalScore ( {V}_{k}^{I} , {ϕ}_{k}^{I} ) / len ( {𝒞}_{k}^{I} ) = {\sum }_{v ∈ {𝒞}_{k}^{I}} {( {v}^{T} )}^{T} {ϕ}_{k}^{I} / len ( {𝒞}_{k}^{I} ) \qquad ( 4 )$$

The average clustering index

$${s}_{c} = {\sum }_{S {}_{t}^{I} ∈ {S}^{I}} s {}_{t}^{I} / {k}_{i}$$

is calculated based on the clustering indexes

$${s}_{{k}_{i}}^{I}$$

of all the item clusters, and a provided item-specific filtering index s_{d} (the first similarity threshold in the foregoing text) can be dynamically set based on the average clustering index s_{c}.

Filtering may be implemented in the following manner: multiplying a matrix of item features of each item by a matrix of features of a positive sample, to obtain a similarity index (the third similarity index above) between each item v and the positive sample; determining whether the similarity index is less than a filtering index s_{d} (the first similarity threshold above), to determine whether to remove the item v from the universal candidate item set

$${ℛ}_{u}^{T} ;$$

in response to the similarity index being less than the filtering index, retaining the item in the universal candidate item set

$${ℛ}_{u}^{T} ,$$

and in response to the similarity index being greater than or equal to the filtering index, removing the item from the universal

$${ℛ}_{u}^{T} .$$

For example, a calculation manner of the filtering index s_{d} is described in operation 506 below.

In this aspect of this disclosure, third similarity indexes corresponding to all the items in the filtered universal candidate item set

$$\hat{ℛ} {}_{u}^{T}$$

are sorted, and items with third similarity indexes ranking high are uniformly sampled.

Behavior matrices H^{S} and H^{T} of a user u in the source domain and the target domain are given. Based on latest interaction features

$${h}_{u}^{S} and {h}_{u}^{T}$$

in behavior sequences in the source domain and the target domain, a final user interaction feature

$${u}_{u}^{T} = M L {P}^{f} ( {h}_{u}^{S} ‖ {h}_{u}^{T} ) ,$$

that is, the comprehensive interaction feature above is generated.

In this aspect of this disclosure, second similarity indexes between the final user interaction feature

$${u}_{u}^{T}$$

and item embedding features in the filtered universal candidate item set

$$\hat{ℛ} {}_{u}^{T}$$

are calculated, and then, an item is selected from a list of top-ranked items as a universal RHNS.

Referring to the specific concept of assumption 1, it is considered in this aspect of this disclosure that an item closer to a positive sample is more likely to be an FHNS. Therefore, the provided universal RHNS selector helps eliminate an item similar to a positive sample, which is a solution customized to a false negative problem in universal HNSs.

This aspect of this disclosure provides a cross-domain RHNS selector. A cross-domain coarse-grained RHNS selector is configured to sample a cross-domain candidate item set related to a source domain preference of a user, and a cross-domain fine-grained RHNS selector is designed. The selectors respectively eliminate potential FHNSs in cross-domain transfer and potential FHNSs from the cross-domain candidate item set by using user-specific and item-specific dynamic filters, and further samples cross-domain RHNSs in CDR. Details are described below in operation 504 and operation 505.

Operation 504: Sample samples related to a source domain preference of the user in the universal candidate item set, to obtain a cross-domain candidate item set.

Hard negative sampling methods in the related technologies are mostly designed in a CF task, and are difficult to be directly transferred to a CDR scenario. This is because the CDR task introduces additional information from the source domain to accurately model complete preferences of the user. Consequently, these methods can only avoid a false negative problem in a single domain, but cannot resolve a problem of cross-domain positive transfer.

In this aspect of this disclosure, it is assumed that a user having consistent behaviors in the source domain may have similar preferences in the target domain, and a coarse-grained RHNS selector is provided to accurately model cross-domain preferences of the user in the target domain and a cross-domain candidate item set related to the user.

For example, prior behavior matrices H̅^{S} and H̅^{T} in the source domain and the target domain are given. In this aspect of this disclosure, a source domain user cluster [symbol] is generated by performing a K-means clustering algorithm on the prior behavior matrix H̅^{S} of the user in the source domain. Subsequently, based on the source domain user cluster [symbol] and the prior behavior matrix H̅^{T} of the user in the target domain (kᵤ is a quantity of clusters of the source domain user cluster), a center of gravity feature

$${Φ}^{U} = [ {ϕ}_{1}^{U} , {ϕ}_{2}^{U} , … , {ϕ}_{{k}_{u}}^{U} ]$$

∈ [symbol] of the target domain is calculated. The center of gravity feature

$${ϕ}_{k}^{U}$$

of each user cluster is the fourth interaction feature above. A measurement method for a center of gravity feature

$${ϕ}_{k}^{U}$$

of each user cluster is as the following formula (5):

$${ϕ}_{k}^{U} = {\sum }_{u ∈ {𝒞}_{k}^{U}} ( {\overline{h}}_{u , q}^{T} ) / len ( {𝒞}_{k}^{U} ) \qquad ( 5 )$$

$${\overline{h}}_{u , q}^{T}$$

represents an embedding feature of a user u in the behavior sequence in the target domain. The len ( ) function is configured for quickly obtaining a quantity of elements of a sequence (for example, list, tuple, or str) and may be configured for checking a length of a character string, a list, a tuple, a dictionary, or a set.

Based on an embedding feature

$${\overline{h}}_{u , p}^{S}$$

and a center of gravity feature

$${ϕ}_{k}^{U}$$

of a prior behavior in a behavior sequence the source domain, a prior transfer source domain feature

$${\overline{u}}_{u}^{S} = {MLP}^{f} ( {\overline{h}}_{u , p}^{S} ‖ {ϕ}_{k}^{U} )$$

is generated in a final space, k represents an index of a user cluster to which the user u belongs.

Similar to the principle of operation 502, based on prior transfer source domain features

$${\overline{u}}_{u}^{S}$$

(the prior source-domain transfer interaction feature above) and learnable item embedding features V^{T}, cross-domain similarity indexes (the fourth similarity index above) are calculated, and the cross-domain similarity indexes are sorted in descending order. A calculation manner is obtaining products

$${s}_{u}^{S} = [ {\overline{u}}_{u}^{S} {v}_{1}^{T} , … , {\overline{u}}_{u}^{S} {v}_{n}^{T} ]$$

between item features in learnable item embedding features and prior transfer source domain features

$${\overline{u}}_{u}^{S} ,$$

and uniformly extracting a fixed quantity of items from a top range of items ranking high, to form a cross-domain item candidate set

$${ℛ}_{u}^{S} .$$

A cross-domain item candidate set

$${ℛ}_{u}^{S}$$

includes items related to a source domain preference of the user. Therefore, in this aspect of this disclosure, a transfer preference of the user between two domains can be accurately stimulated through fine-grained analysis and processing.

Operation 505: Remove FHNSs in cross-domain transfer and FHNSs from the cross-domain candidate item set, and sample RHNSs in the cross-domain candidate item set.

An objective of CDR is to transfer informative knowledge from the source domain to the target domain to improve performance in the target domain. Because items belong to different domains, and user preferences in a plurality of domains have inherent data bias, it is challenging to implement uniform modeling of the user preferences in different domains. The provided cross-domain RHNS is mainly modeling preferences in a mainstream target domain by performing unsupervised clustering on similar source domain preferences. It performs well in a broad sense, and over optimization of cross-domain RHNSs actually exacerbates biases and introduces additional negative information to users with consistent preferences in the source domain and the target domain. As shown in the middle part of FIG. 1, in a cross-domain transfer process, users clustered into a same cluster in a user interaction feature space in the source domain display a clear distribution difference in a user interaction feature space in the target domain. This is due to different mapping methods of different users. A large amount of source domain information actually exists in the real world. As a result, some users are more easily dominated by a mainstream preference transfer mode in a transfer process.

In this aspect of this disclosure, outliers are defined as users exhibiting similar preferences in the source domain, but preferences significantly different from those in mainstream transfer in the target domain. In this aspect of this disclosure, a user-specific dynamic filter is provided, to include outliers into an optimization range of cross-domain RHNSs. A user cluster index k is given. In this aspect of this disclosure, a list

$${S}_{k}^{U}$$

of scores between an embedding feature matrix

$${U}_{k}^{U} ∈ {ℝ}^{len ( {𝒞}_{k}^{U} ) \times d}$$

of last behaviors in prior target domain behavior sequences of all the users in the user cluster

$${𝒞}_{k}^{U}$$

and a target domain center feature

$${ϕ}_{k}^{U}$$

is defined as the following formula (6)

$${S}_{k}^{U} = CalScore ( {U}_{k}^{U} , {ϕ}_{k}^{U} ) = {( {U}_{k}^{U} )}^{T} {ϕ}_{k}^{U} \qquad ( 6 )$$

Then, in this aspect of this disclosure, the list

$${S}_{k}^{U}$$

of scores is sorted, and len

$$( {𝒞}_{k}^{U} ) * {w}_{o}$$

user having the lowest scores in the list of scores are selected based on a predefined weight wₒ as outliers. A CDR model corresponding to the outliers is trained based on the universal RHNSs and the cross-domain RHNSs, and a CDR model corresponding to only universal RHNSs is used for other users.

In addition to an inherent multi-domain preference bias, there is a problem of negative information transfer in a cross-domain preference modeling process, that is, excessive dependency on a cross-domain item candidate set may introduce a bias in selection of cross-domain RHNSs (see assumption 2). To eliminate the bias in cross-domain preference modeling, in this aspect of this disclosure, an item-specific dynamic filter is designed, to filter out some items excessively similar to positive samples from the candidate cross-domain item set. An item-specific filter is designed based on an unsupervised item similarity, and a cross-domain setting does not change an internal relationship between items thereof.

The cross-domain item candidate set is filtered by using an item-specific universal filtering index mentioned in operation 503. By comparing a similarity index between an item and a positive sample and an item-specific filtering index Sa, it is evaluated whether to remove the item v from the cross-domain candidate item set.

Transferred source domain features

$${u}_{u}^{s} = {MLP}^{f} ( {h}_{u}^{s} ‖ {ϕ}_{k}^{U} )$$

are modeled through the latest behavior embedding features

$${h}_{u}^{s}$$

in the source domain and the center of gravity features in the target domain

$${ϕ}_{k}^{U}$$

(k indicates an index of a source domain user cluster to which u belongs). Finally, similarity indexes between source domain features

$${u}_{u}^{s}$$

of the transfer and item embedding features in the filtered cross-domain candidate item set

$${\hat{ℛ}}_{u}^{s}$$

are calculated, and then, a fixed quantity of items in items ranking high are used as cross-domain HNSs.

Operation 506: Obtain a quantity of RHNSs in the training sample set needed for training the CDR model.

As shown in assumption 3, including all HNSs in an initial stage of training may lead to a calculation waste, sub-optimal performance, and an excessively large gradient, which may further hinder the model from converging to a global minimum value, Therefore, in this aspect of this disclosure, a generalization capability and a convergence rate of the CDR model are improved by using a CL method. CL is a general training strategy, imitates a human learning sequence in a curriculum, and slowly increases difficulty of training samples as a model is optimized.

In this aspect of this disclosure, two CL methods are designed, including an optimization-based CL method and a filtering-based CL method. The former refers to dynamically adjusting a proportion of RHNSs in NSs, which enables the model to start from a smooth target, and makes it easier to find a global minimum value. At this time, a hyperparameter μ controls a starting period in CL, ψ is a quantity of period intervals in CL, and n represents a quantity of additional RHNSs. Reference is made to a formula (7) of a quantity nᵣ of RHNSs in the NSs:

$${n}_{r} = \{ \begin{matrix}0 , & e \leq μ \\ min ( η * ⌈ \frac{( e - μ )}{ψ} ⌉ , \frac{{n}_{n}}{2} ) , & e > μ ,\end{matrix} \qquad ( 7 )$$

e is a current period, and nₙ represents a quantity of NSs. The foregoing parameters are the same in each data set, that is, μ=5, ψ=2, and η=1.

In contrast, the latter CL task is configured to dynamically adjust a to-be-filtered range passing the item candidate set and the cross-domain item candidate set, to alleviate a case of including harder NSs (potential FHNS) into training. An initial filtering size of a preset hyperparameter χ=5 and τ=1.15 respectively represent periodic attenuation ratios. A provided item-specific filtering index defined as formula (8):

$${s}_{d} = \{ \begin{matrix}+ ∞ , & e \leq μ \\ min ( {s}_{c} , \frac{{s}_{c}}{χ} * {τ}^{⌈ \frac{e - μ}{ψ} ⌉} ) , & e > μ ,\end{matrix} \qquad ( 8 )$$

Operation 507: Train the CDR model based on the training sample set.

In this aspect of this disclosure, a predicted credibility

$${\hat{y}}^{T} = CalScore ( {u}^{T} , {v}_{q + 1}^{T} ) = {( {u}^{T} )}^{T} {d}_{q + 1}^{T}$$

between a user and an item

$${v}_{p + 1}^{T}$$

is calculated based on a final user interaction feature u^{T} and a feature

$${v}_{q + 1}^{T}$$

of a target item. The loss function [symbol] is expressed as the following formula (9):

$$ℒ = - {\sum }_{( u , d ) ∈ {R}^{T}} [ {y}_{u , d}^{T} log {\hat{y}}_{u , d}^{T} + ( 1 - {y}_{u , d}^{T} ) log ( 1 - {\hat{y}}_{u , d}^{T} ) ] \qquad ( 9 )$$

R^{T} is a training set of the target domain,

$${y}_{u , d}^{T} = 1 and {y}_{u , d}^{T} = 0$$

respectively represent a positive sample and a corresponding NS, and

$${\hat{y}}_{u , d}^{T}$$

represents predicted probabilities of (u, d).

In this aspect of this disclosure, a greater recommendation performance improvement can be obtained when performing CDR from a denser domain to a sparser domain (Game->Toy, which is recommending toys based on game samples, and Movie->Book, which is recommending books based on movie samples), which proves the practical significance of RHNSs in cross-domain knowledge transfer, and also proves that both universal RHNSs and cross-domain RHNSs provided in this aspect of the present application can achieve a significant improvement in consistency based on the related state-of-the-art model (SOTA) negative sampling method. This aspect of this disclosure can be applied to the following scenario: CDR between a platform with sparse consumption behaviors and a platform with abundant consumption behaviors.

The following explains and describes, with reference to the experimental results, effects of a sample processing method for a CDR model provided in an aspect of this disclosure. Through comparison with the related SOTA algorithm, effectiveness and universality of the method in this aspect of this disclosure are comprehensively analyzed. In performance comparison, three classic evaluation indexes are selected to evaluate the effectiveness of the provided sample processing method for a CDR model according to this aspect of this disclosure, including NDCG@k (N@k), HitRate@k (H@k), and an area under curve (AUC) under an ROC curve and bounded by a coordinate axis, where k is selected from [5, 10, 20, 50]. In this aspect of this disclosure, 99 NSs are randomly extracted for each positive sample in a test set, and in an experimental result table, a best result is shown in bold, and a best effect of a baseline algorithm is shown in underline.

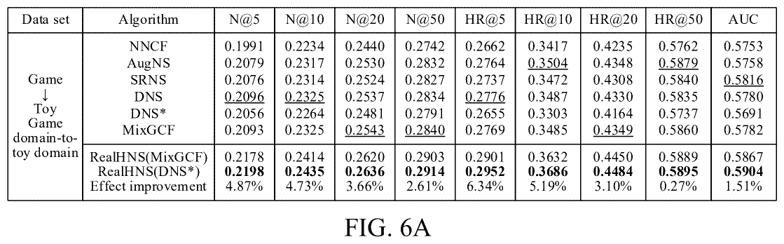

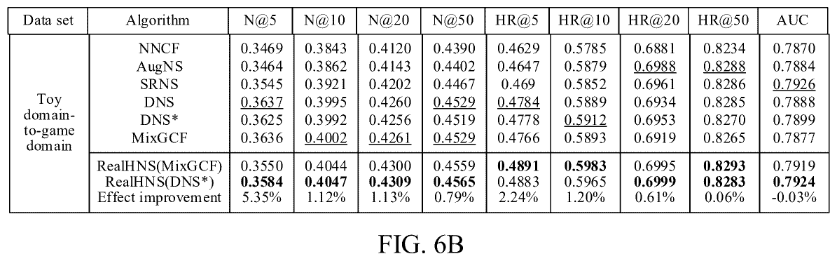

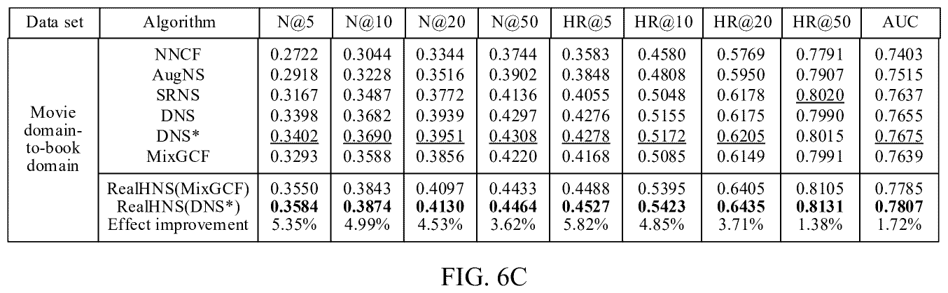

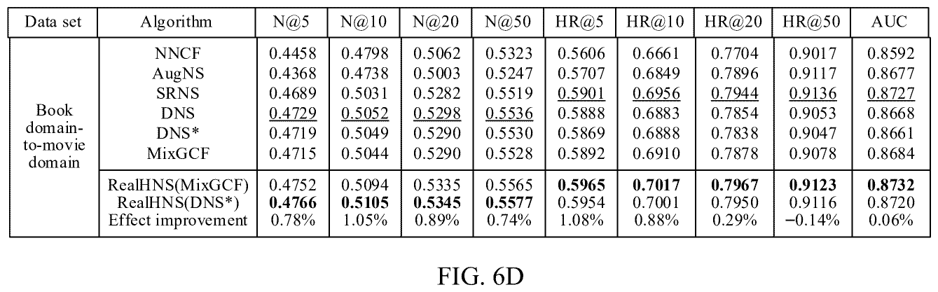

FIG. 6A shows a first experimental result table according to an aspect of this disclosure. FIG. 6A exhibits experimental results of game domain-to-toy domain recommendation. Negative sampling methods in the related technology involved in the table include: negative sampling with network-generated candidates (NNCF), AugNS, a sparse random negative sampling (SRNS) method, a dynamic negative sampling (DNS) method, DNS*, and MixGCF.

FIG. 6B shows a second experimental result table according to an aspect of this disclosure, which exhibits experimental results of toy domain-to-game domain recommendation.

FIG. 6C shows a third experimental result table according to an aspect of this disclosure, which exhibits experimental results of movie domain-to-book domain recommendation.

FIG. 6D shows a fourth experimental result table according to an aspect of this disclosure, which exhibits experimental results of book domain-to-movie domain recommendation.

The following conclusions are obtained by observing the experimental result tables in FIG. 6A to FIG. 6D: (1) This aspect of this disclosure is significantly better than all baseline algorithms in four data sets with a significance level p of less than 0.05 and an average error range of less than 0.003. The sample processing method for a CDR model provided in this aspect of this disclosure is more enhanced in terms of a relatively small k and an index (NDCG) that is more sensitive to a ranking order because this aspect of this disclosure focuses on distinguishing HNSs that are more favorable at first several positions of a ranking list. Such superiority is consistent in four cross-domain settings based on two hard negative sampling methods, indicating that aspects of this disclosure can bring ideal improvements to various hard negative sampling methods. In addition, this also proves the necessity of capturing specific cross-domain RHNSs to improve CDR. This aspect of this disclosure focuses on a sampling environment (including 10 random NSs and 10 HNSs, and more HNSs may reduce impact of sampling) that is more challenging and is more common in an actual recommendation system. Compared with a classic hard negative sampling method, in this aspect of this disclosure, a consistency improvement (1% to 5%) brought by RealNHS (DNS*) in FIG. 6A to FIG. 6D is sufficient for describing universality and effectiveness.

(2) Based on a challenging setting of fixedly selecting 20 NSs in this aspect of this disclosure, no hard negative sampling baseline algorithm can consistently exceed other baseline algorithms in all data sets (sometimes even worse effect than using only random NSs). Most related hard negative sampling methods (for example, DNS* and MixGCF) rely only on selecting hardest items from some subsets of candidate items to alleviate impact of FHNSs, causing excessive dependence on quality of a subset of randomly selected candidate items. Therefore, they perform worse on a data set (for example, game-to-toy recommendation Game->Toy and movie-to-book recommendation Movie->Book) having a larger item corpus or sparser object behaviors. The improvements of this aspect of this disclosure over the related hard negative sampling method confirm the importance of the following: (1) An item-specific filter provided in universal RHNSs can provide an unbiased information gradient for a recommendation model. (2) Clear cross-domain RHNSs can simulate preference changes of a user in a plurality of domains, and are included into a training process through a CL framework.

(3) By comparing improvements between different data sets, in this aspect of this disclosure, settings of game-to-toy recommendation Game->Toy and movie-to-book recommendation Movie->Book are better performed, which reflects that in this aspect of this disclosure, informative knowledge can be transferred from a denser source domain to a sparser target domain (similar to a related CDR method). In addition, in all data sets, improvements of this aspect of this disclosure over MixGCF and DNS* are also significant, indicating that this aspect of this disclosure has the capability of bringing further consistency improvements to different baseline hard negative sampling algorithms. Benefiting from the novel cross-domain RHNS and user-specific and item-specific dynamic filters in CDR, this aspect of this disclosure is significantly better than other negative sampling methods in all data sets.

The following continues to describe an example structure in which a sample processing apparatus 455 for a CDR model provided in an aspect of this disclosure is implemented as a software module. In some aspects, as shown in FIG. 2, software modules in the sample processing apparatus 455 for a CDR model stored in the memory 450 may include: a sample obtaining module 4551, configured to obtain a plurality of recommended items in a target domain, the recommended item being configured for recommendation to a sample object, the sample obtaining module 4551 being configured to fuse a first interaction feature of a sample object in a source domain and a second interaction feature of the sample object in the target domain, to obtain a fused interaction feature of the sample object, the first interaction feature being an interaction feature of the sample object in the source domain, and the second interaction feature being an interaction feature of the sample object in the target domain; and a sample filtering module 4552, configured to determine similarity indexes between the fused interaction feature and all the recommended items; and filter a plurality of HNSs from the plurality of recommended items based on the similarity indexes, and combine the plurality of HNSs into a set of candidate recommended items. The sample obtaining module 4551 is configured to obtain a third interaction feature and a fourth interaction feature of the sample object, the third interaction feature being an interaction feature that is of an interactive behavior of the sample object in the source domain and that is time-effective in the source domain, and the fourth interaction feature being a cluster center of the second interaction features of a plurality of sample objects in the target domain. The sample obtaining module 4551 is configured to fuse a third interaction feature and a fourth interaction feature of the sample object, to obtain a transfer interaction feature of the sample object. The sample filtering module 4552 is configured to filter a plurality of RHNSs from the plurality of HNSs based on similarity indexes between the transfer interaction feature and all recommended items in the set of candidate recommended items, the plurality of RHNSs being configured for training the CDR model.

In some aspects, the sample obtaining module 4551 is configured to, before fusing the first interaction feature and the second interaction feature of the sample object, to obtain the fused interaction feature of the sample object, obtain source domain items corresponding to all interactive behaviors performed by the sample object in the source domain, and perform feature extraction on all the source domain items, to obtain source domain item features; combine, based on an order in which all the interactive behaviors in the source domain are performed, all the source domain item features into the first interaction feature in a sequence form; obtain target domain items corresponding to all interactive behaviors performed by the sample object in the target domain, and perform feature extraction on all the target domain items, to obtain target domain item features; and combine, based on an order in which all the interactive behaviors in the target domain are performed, all the target domain item features into the second interaction feature in a sequence form.

In some aspects, the fused interaction feature includes: a prior interaction feature of the sample object in the target domain and a comprehensive interaction feature of the sample object for the source domain and the target domain. The sample obtaining module 4551 is configured to perform feature prediction based on all the source domain item features in the first interaction feature in a sequence form, to obtain a first predicted feature, the first predicted feature being configured to represent a prior interactive behavior of the sample object in the source domain; perform feature prediction based on all the target domain item features in the second interaction feature in a sequence form, to obtain a second predicted feature, the second predicted feature being configured to represent a prior interactive behavior of the sample object in the target domain; activate the first predicted feature and the second predicted feature by invoking a rectified linear function, to obtain the prior interaction feature of the sample object in the target domain; and activate the following parameters by invoking the rectified linear function, to obtain the comprehensive interaction feature of the sample object for the source domain and the target domain: a last source domain item feature in the first interaction feature in a sequence form, and a last target domain item feature in the second interaction feature in a sequence form.

In some aspects, the sample filtering module 4552 is configured to obtain first similarity indexes between the prior interaction feature of the sample object in the target domain and recommended item features respectively corresponding to all the recommended items; and obtain second similarity indexes between the comprehensive interaction feature of the sample object for the source domain and the target domain and the recommended item features respectively corresponding to all the recommended items.

In some aspects, the sample filtering module 4552 is configured to sort all the recommended items in descending order based on the first similarity indexes, and combine at least some of the recommended items located at a head in a descending sorting result into a first candidate set; obtain a positive sample feature of a positive sample corresponding to the sample object, and obtain third similarity indexes between the positive sample feature and recommended item features of all the recommended items in the first candidate set; delete recommended items whose third similarity indexes are greater than a first similarity threshold from the first candidate set, to obtain a second candidate set; and sort all the recommended items in the second candidate set in descending order based on the second similarity indexes, and combine at least some of the recommended items located at a head in a descending sorting result into the set of candidate recommended items.

In some aspects, the sample obtaining module 4551 is configured to use the last source domain item feature in the first interaction feature in a sequence form as the third interaction feature, the last source domain item feature being configured to represent an interactive behavior finally performed by the sample object in the source domain; obtain first ratios of the following parameters respectively corresponding to a plurality of sample objects: the second predicted feature of the sample object in the target domain and a quantity of objects in an object cluster to which the sample objects belong; and add up the first ratios to obtain the fourth interaction feature.

In some aspects, the transfer interaction feature includes: a prior source-domain transfer interaction feature of the sample object and a source-domain transfer interaction feature of the sample object. The sample obtaining module 4551 is configured to activate the first predicted feature and the fourth interaction feature of the sample object by invoking the rectified linear function, to obtain the prior source-domain transfer interaction feature of the sample object; and invoke the rectified linear function to activate the third interaction feature and the fourth interaction feature, to obtain the source-domain transfer interaction feature of the sample object.

In some aspects, the sample filtering module 4552 is configured to obtain fourth similarity indexes between the prior source-domain transfer interaction feature of the sample object and the recommended item features respectively corresponding to all the recommended items; sort all the HNSs in the set of candidate recommended items in descending order based on the fourth similarity indexes, and combine at least some of the HNSs located at a head in a descending sorting result into a third candidate set; obtain the positive sample feature of the positive sample corresponding to the sample object, and obtain third similarity indexes between the positive sample feature and recommended item features of all the recommended items in the third candidate set; delete recommended items whose third similarity indexes are greater than a second similarity threshold from the third candidate set, to obtain a fourth candidate set; obtain sixth similarity indexes between the source-domain transfer interaction feature of the sample object and the recommended item features respectively corresponding to all the recommended items; and sort all the recommended items in the fourth candidate set in descending order based on the sixth similarity indexes, and use at least some of the recommended items located at a head in a descending sorting result as the RHNSs.

In some aspects, the sample filtering module 4552 is configured to, after obtaining the plurality of recommended items in the target domain, obtain recommended item features of the plurality of recommended items, item clusters to which the plurality of recommended items belong, and cluster center item features corresponding to all the item clusters; determine clustering indexes respectively corresponding to all the item clusters based on the recommended item features of all the recommended items included in all the item clusters and the cluster center item features; use a sum of ratios of the following parameters of all the item clusters as an average clustering index corresponding to the plurality of recommended items: clustering indexes of the item clusters and a clustering quantity of the item clusters; determine an attenuated average clustering index based on a first difference between a current moment and a start moment of sample processing and the average clustering index; and use a smaller value of the average clustering index and the attenuated average clustering index as the first similarity threshold.

In some aspects, the sample filtering module 4552 is configured to perform the following processing for each of the item clusters: obtaining first products between transposes of all the recommended item features in the item cluster and a cluster center item feature; respectively obtaining second ratios of all the first products to a quantity of recommended items in the item cluster; and using a sum of the second ratios as a clustering index of the item cluster.

In some aspects, the sample filtering module 4552 is configured to obtain a preconfigured periodic attenuation ratio, an initial filtering index, and a quantity of cycles for sample processing; obtain a third ratio between the average clustering index and the initial filtering index; use a ratio between the first difference and the quantity of cycles as an index, and use the periodic attenuation ratio as a base, to form a time attenuation parameter; and use a product of the third ratio and the time attenuation parameter as the attenuated average clustering index.

In some aspects, the model training module 4553 is configured to, after filtering the plurality of RHNSs from the plurality of HNSs based on the similarity indexes between the transfer interaction feature and all the recommended items in the set of candidate recommended items, obtain a training sample set, the training sample set including: a sample interaction feature of a sample object, a plurality of sample recommended items as positive samples, and a plurality of sample recommended items as NSs, the NSs including a preconfigured quantity of RHNSs, sample tag values of the NSs being 0, and sample tag values of the positive samples being 1; invoke an initialized CDR model based on the training sample set to perform recommendation result prediction, to obtain recommendation results respectively corresponding to all the sample recommended items; determine a loss function of the CDR model based on differences between the recommendation results respectively corresponding to all the sample recommended items and the sample tag values; and update a parameter of the initialized CDR model based on the loss function, to obtain the trained CDR model.

In some aspects, the model training module 4553 is configured to perform the following processing for all the sample recommended items: multiplying a transpose matrix of an interaction feature matrix of the sample object by matrices of the recommended item features of all the sample recommended items, to obtain predicted probabilities of the sample recommended items; obtaining second products of logarithms of the predicted probabilities and the sample tag values of the sample recommended items; obtaining a second difference between 1 and the sample tag value, and obtaining a logarithm of a third difference between 1 and the predicted probabilities; multiplying the second differences by the logarithms of the third differences, to obtain third products; using sums of the second products and the third products as sub-losses of the sample recommended items; and adding up all the sub-losses to obtain the loss function of the CDR model.

An aspect of this disclosure provides a computer program product, including a computer program or computer-executable instructions, the computer program or the computer-executable instructions being stored in a computer-readable storage medium. A processor of an electronic device reads the computer-executable instructions from the computer-readable storage medium. The processor executes the computer-executable instructions, to cause the electronic device to perform the foregoing sample processing method for a CDR model according to aspects of this disclosure.

An aspect of this disclosure provides a computer-readable storage medium, such as a non-transitory computer-readable storage medium having computer-executable instructions or a computer program stored therein. When executed by a processor, the computer-executable instructions or the computer program causes the processor to perform the sample processing method for a CDR model provided in aspects of this disclosure, for example, the sample processing method for a CDR model shown in FIG. 3A.

In some aspects, the computer-readable storage medium may be a memory such as a FRAM, a ROM, a PROM, an EPROM, an EEPROM, a flash memory, a magnetic surface memory, an optical disk, or a CD-ROM, or may be various devices including one or any combination of the foregoing memories.

In some aspects, the computer-executable instructions may be written in any form of programming language (including a compiled or interpreted language, or a declarative or procedural language) by using the form of a program, software, a software module, a script or code, and may be deployed in any form, including being deployed as an independent program or being deployed as a module, a component, a subroutine, or another unit suitable for use in a computing environment.

In an example, the computer-executable instructions may, but do not necessarily, correspond to a file in a file system, and may be stored in a part of a file that saves another program or other data, for example, be stored in one or more scripts in a hypertext markup language (HTML) file, stored in a file that is specially used for a program in discussion, or stored in the plurality of collaborative files (for example, be stored in files of one or modules, subprograms, or code parts).

In an example, the executable instructions may be deployed for execution on one electronic device, execution on a plurality of electronic devices located at one location, or execution on a plurality of electronic devices that are distributed at a plurality of locations and that are interconnected through a communication network.

In conclusion, in this aspect of this disclosure, a plurality of recommended items are initially filtered based on a fused interaction feature of a sample object between different domains, to obtain a set of candidate recommended items formed by combining HNSs. The set of candidate recommended items is filtered based on an interaction feature of a sample object transferred between different domains, to obtain RHNSs for training the CDR model. Through a plurality rounds of filtering, accuracy of RHNSs obtained through filtering is improved. The RHNSs obtained through filtering are configured for training the CDR model, which can improve accuracy of information recommendation of the model in the target domain.

The foregoing descriptions are merely some aspects of this disclosure and are not intended to limit the scope of this disclosure. Any modification, equivalent replacement, or improvement made without departing from the spirit and range of this disclosure shall fall within the scope of this disclosure.

What is claimed is:

1. A method for processing samples for a cross-domain recommendation (CDR) model, the method comprising:
obtaining a plurality of recommended items in a target domain;
fusing a first interaction feature of a sample object in a source domain with a second interaction feature of the sample object in the target domain to obtain a fused interaction feature of the sample object;
determining similarity scores between the fused interaction feature and each of the plurality of recommended items;
filtering a plurality of hard negative samples (HNSs) from the plurality of recommended items based on the similarity scores;
combining the plurality of HNSs into a candidate recommended item set;
fusing a third interaction feature with a fourth interaction feature to obtain a transfer interaction feature of the sample object, the third interaction feature indicating time-sensitive interaction behavior of the sample object in the source domain, and the fourth interaction feature indicating a cluster center of the second interaction feature; and
filtering a plurality of real hard negative samples (RHNSs) from the plurality of HNSs based on similarity scores between the transfer interaction feature and each of the plurality of HNSs in the candidate recommended item set, the plurality of RHNSs being used to train the CDR model.

2. The method according to claim 1, further comprising:
obtaining source domain items corresponding to interaction behaviors performed by the sample object in the source domain;
performing feature extraction on the source domain items to obtain source domain item features;
combining, based on a temporal order of the interaction behaviors in the source domain, the source domain item features into the first interaction feature in sequence form;
obtaining target domain items corresponding to interaction behaviors performed by the sample object in the target domain;
performing feature extraction on the target domain items to obtain target domain item features; and
combining, based on a temporal order of the interaction behaviors in the target domain, the target domain item features into the second interaction feature in sequence form.

3. The method according to claim 2, wherein the fused interaction feature includes a prior interaction feature of the sample object in the target domain and a comprehensive interaction feature of the sample object for the source domain and the target domain; and
the fusing the first interaction feature comprises:
performing feature prediction based on the source domain item features in the first interaction feature to obtain a first predicted feature indicating a predicted interaction behavior of the sample object in the source domain;
performing feature prediction based on the target domain item features in the second interaction feature to obtain a second predicted feature indicating a predicted interaction behavior of the sample object in the target domain;
invoking a rectified linear function to activate the first predicted feature and the second predicted feature to obtain the prior interaction feature;
invoking the rectified linear function to activate a last source domain item feature in the first interaction feature and a last target domain item feature in the second interaction feature to obtain the comprehensive interaction feature; and
combining the prior interaction feature and the comprehensive interaction feature to obtain the fused interaction feature.

4. The method according to claim 3, wherein the determining the similarity scores comprises:
obtaining recommended item features for the plurality of recommended items;
obtaining first similarity scores between the prior interaction feature of the sample object in the target domain and the recommended item features; and
obtaining second similarity scores between the comprehensive interaction feature and the recommended item features corresponding to each of the plurality of recommended items.

5. The method according to claim 4, wherein the filtering the plurality of RHNSs comprises:
sorting the plurality of recommended items in descending order based on the first similarity scores;
selecting a portion of the sorted recommended items to form a first candidate set;
obtaining a positive sample feature of a positive sample corresponding to the sample object;
obtaining third similarity scores between the positive sample feature and recommended item features of each of the recommended items in the first candidate set;
removing, from the first candidate set, the recommended items having third similarity scores greater than a first similarity threshold to obtain a second candidate set;
sorting the recommended items in the second candidate set in descending order based on the second similarity scores; and
selecting a portion of the sorted recommended items in the second candidate set as the plurality of HNSs to form the candidate recommended item set.

6. The method according to claim 3, further comprising:
determining the last source domain item feature in the first interaction feature as the third interaction feature, the last source domain item feature indicating a most recent interaction behavior performed by the sample object in the source domain;
obtaining first ratios of a plurality of sample objects, each of the first ratios being based on the second predicted feature of a respective sample object divided by a number of objects in an object cluster that includes the respective sample object; and
adding the first ratios to obtain the fourth interaction feature.

7. The method according to claim 6, wherein the transfer interaction feature includes a prior source-domain transfer interaction feature of the sample object and a source-domain transfer interaction feature of the sample object, and
the fusing the third interaction feature comprises:
invoking the rectified linear function to activate the first predicted feature and the fourth interaction feature to obtain the prior source-domain transfer interaction feature; and
invoking the rectified linear function to activate the third interaction feature and the fourth interaction feature to obtain the source-domain transfer interaction feature.

8. The method according to claim 7, wherein the filtering the plurality of RHNSs comprises:
obtaining fourth similarity scores between the prior source-domain transfer interaction feature of the sample object and recommended item features of each of the plurality of HNSs in the candidate recommended item set;
sorting the plurality of HNSs in the candidate recommended item set in descending order based on the fourth similarity scores;
selecting a portion of the sorted HNSs to form a third candidate set;
obtaining a positive sample feature of a positive sample corresponding to the sample object;
obtaining third similarity scores between the positive sample feature and the recommended item features of each of the recommended items in the third candidate set;
removing, from the third candidate set, the recommended items having third similarity scores greater than a second similarity threshold to obtain a fourth candidate set;
obtaining sixth similarity scores between the source-domain transfer interaction feature of the sample object and the recommended item features of each of the recommended items in the fourth candidate set;
sorting the recommended items in the fourth candidate set in descending order based on the sixth similarity scores; and
selecting a portion of the sorted recommended items in the fourth candidate set as the plurality of RHNSs.

9. The method according to claim 5, further comprising:
identifying item clusters from the plurality of recommended items;
obtaining cluster center item features corresponding to the item clusters;
determining a clustering index for each item cluster based on the recommended item features of the recommended items within the respective item cluster and the cluster center item feature of the respective item cluster;
calculating an average clustering index as a sum of ratios, each ratio including the clustering index of a respective item cluster divided by a total number of the item clusters;
determining an attenuated average clustering index based on a first difference between a current time and a sample processing time and the average clustering index; and
selecting a smaller value between the average clustering index and the attenuated average clustering index as the first similarity threshold.

10. The method according to claim 9, wherein the determining the clustering index comprises:
obtaining first products between transposes of the recommended item features of the recommended items in the item cluster and the corresponding cluster center item feature;
dividing each of the first products by a number of recommended items in the item cluster to obtain second ratios; and
adding the second ratios to obtain the clustering index of the item cluster.

11. The method according to claim 9, wherein the determining the attenuated average clustering index comprises:
obtaining a periodic attenuation ratio, an initial filtering index, and a number of sample processing cycles;
dividing the average clustering index by the initial filtering index to obtain a third ratio;
forming a time attenuation parameter by raising the periodic attenuation ratio to a power equal to a ratio of the first difference to the number of sample processing cycles; and
multiplying the third ratio by the time attenuation parameter to obtain the attenuated average clustering index.

12. The method according to claim 1, further comprising:
obtaining a training sample set including sample interaction features of sample objects, a plurality of sample recommended items as positive samples, and a plurality of sample recommended items as negative samples (NSs), the negative samples including a preconfigured quantity of the RHNSs, sample labels values of the negative samples being 0, and sample label values of the positive samples being 1;
invoking an initialized CDR model based on the training sample set to perform recommendation result prediction to obtain recommendation results corresponding to each sample recommended item; and
determining a loss function of the CDR model based on differences between the recommendation results and the sample label values for each recommended item; and
updating parameters of the initialized CDR model based on the loss function to obtain the trained CDR model.

13. The method according to claim 12, wherein the determining the loss function of the CDR model comprises:
for each sample recommended item in the training sample set,
multiplying a transpose of an interaction feature matrix of the sample object by a matrix of recommended item features of the respective sample recommended item to obtain a predicted probability of the respective sample recommended item;
obtaining a second product by multiplying a logarithms of the predicted probability by a sample label value of the respective sample recommended item;
obtaining a second difference by subtracting the sample label value by 1;
obtaining a logarithm of a third difference by subtracting the predicted probability from 1;
obtaining a third product by multiplying the second difference by the logarithm of the third difference;
adding the second product and the third product to obtain a sub-loss for the respective sample recommended item; and
adding the sub-losses from the sample recommended items to obtain the loss function of the CDR model.

14. An apparatus for processing samples for a cross-domain recommendation (CDR) model, the apparatus comprising:
processing circuitry configured to:
obtain a plurality of recommended items in a target domain;
fuse a first interaction feature of a sample object in a source domain with a second interaction feature of the sample object in the target domain to obtain a fused interaction feature of the sample object;
determine similarity scores between the fused interaction feature and each of the plurality of recommended items;
filter a plurality of hard negative samples (HNSs) from the plurality of recommended items based on the similarity scores;
combine the plurality of HNSs into a candidate recommended item set;
fuse a third interaction feature with a fourth interaction feature to obtain a transfer interaction feature of the sample object, the third interaction feature indicating time-sensitive interaction behavior of the sample object in the source domain, and the fourth interaction feature indicating a cluster center of the second interaction feature; and
filter a plurality of real hard negative samples (RHNSs) from the plurality of HNSs based on similarity scores between the transfer interaction feature and each of the plurality of HNSs in the candidate recommended item set, the plurality of RHNSs being used to train the CDR model.

15. The apparatus according to claim 14, wherein the processing circuitry is configured to:
obtain source domain items corresponding to interaction behaviors performed by the sample object in the source domain;
perform feature extraction on the source domain items to obtain source domain item features;
combine, based on a temporal order of the interaction behaviors in the source domain, the source domain item features into the first interaction feature in sequence form;
obtain target domain items corresponding to interaction behaviors performed by the sample object in the target domain;
perform feature extraction on the target domain items to obtain target domain item features; and
combine, based on a temporal order of the interaction behaviors in the target domain, the target domain item features into the second interaction feature in sequence form.

16. The apparatus according to claim 15, wherein the fused interaction feature includes a prior interaction feature of the sample object in the target domain and a comprehensive interaction feature of the sample object for the source domain and the target domain; and
the processing circuitry is configured to:
perform feature prediction based on the source domain item features in the first interaction feature to obtain a first predicted feature indicating a predicted interaction behavior of the sample object in the source domain;
perform feature prediction based on the target domain item features in the second interaction feature to obtain a second predicted feature indicating a predicted interaction behavior of the sample object in the target domain;
invoke a rectified linear function to activate the first predicted feature and the second predicted feature to obtain the prior interaction feature;
invoke the rectified linear function to activate a last source domain item feature in the first interaction feature and a last target domain item feature in the second interaction feature to obtain the comprehensive interaction feature; and
combine the prior interaction feature and the comprehensive interaction feature to obtain the fused interaction feature.

17. The apparatus according to claim 16, wherein the processing circuitry is configured to:
obtain recommended item features for the plurality of recommended items;
obtain first similarity scores between the prior interaction feature of the sample object in the target domain and the recommended item features; and
obtain second similarity scores between the comprehensive interaction feature and the recommended item features corresponding to each of the plurality of recommended items.

18. The apparatus according to claim 17, wherein the processing circuitry is configured to:
sort the plurality of recommended items in descending order based on the first similarity scores;
select a portion of the sorted recommended items to form a first candidate set;
obtain a positive sample feature of a positive sample corresponding to the sample object;
obtain third similarity scores between the positive sample feature and recommended item features of each of the recommended items in the first candidate set;
remove, from the first candidate set, the recommended items having third similarity scores greater than a first similarity threshold to obtain a second candidate set;
sort the recommended items in the second candidate set in descending order based on the second similarity scores; and
select a portion of the sorted recommended items in the second candidate set as the plurality of HNSs to form the candidate recommended item set.

19. The apparatus according to claim 16, wherein the processing circuitry is configured to:
determine the last source domain item feature in the first interaction feature as the third interaction feature, the last source domain item feature indicating a most recent interaction behavior performed by the sample object in the source domain;
obtain first ratios of a plurality of sample objects, each of the first ratios being based on the second predicted feature of a respective sample object divided by a number of objects in an object cluster that includes the respective sample object; and
add the first ratios to obtain the fourth interaction feature.

20. A non-transitory computer-readable storage medium storing instructions which, when executed by a processor, cause the processor to perform:
obtaining a plurality of recommended items in a target domain;
fusing a first interaction feature of a sample object in a source domain with a second interaction feature of the sample object in the target domain to obtain a fused interaction feature of the sample object;
determining similarity scores between the fused interaction feature and each of the plurality of recommended items;
filtering a plurality of hard negative samples (HNSs) from the plurality of recommended items based on the similarity scores;
combining the plurality of HNSs into a candidate recommended item set;
fusing a third interaction feature with a fourth interaction feature to obtain a transfer interaction feature of the sample object, the third interaction feature indicating time-sensitive interaction behavior of the sample object in the source domain, and the fourth interaction feature indicating a cluster center of the second interaction feature; and
filtering a plurality of real hard negative samples (RHNSs) from the plurality of HNSs based on similarity scores between the transfer interaction feature and each of the plurality of HNSs in the candidate recommended item set, the plurality of RHNSs being used to train a cross-domain recommendation (CDR) model.
